(19) United States
(12) Patent Application Publication
(10) Pub. No.: US 2026/0064447 A1
(43) Pub. Date: Mar. 5, 2026

(54) Interactive Data Tour Creator for Dashboards

(71) Applicant: Salesforce, Inc., San Francisco, CA (US)

(72) Inventors: Nicole Barbosa SULTANUM, Seattle, WA (US); Md Naimul HOQUE, Seattle, WA (US)

(21) Appl. No.: 19/026,352

(22) Filed: Jan. 16, 2025

Related U.S. Application Data
(60) Provisional application No. 63/691,311, filed on Sep. 5, 2024.
(60) Provisional application No. 63/694,784, filed on Sep. 13, 2024.

(51) Int. Cl. G06F 9/451; G06F 3/0481

(52) U.S. Cl. CPC G06F 9/453; G06F 3/0481

(57) ABSTRACT

A computer-implemented method can be used for creating and presenting interactive data tours for dashboards. The computer receives a communication intent for a data tour of a dashboard, records user interactions with components of the dashboard and generates steps for the data tour based on the recorded user interactions. The computer also generates (e.g., using a Large Language Model) an explanatory title and a description based on linked dashboard components and the communication intent, for each steps. The computer also presents an interface for editing the data tour, receives edits to the data tour, and stores the edited tour. In response to a request to play the data tour, the computer presents the data tour as an interactive step-by-step guide overlaid on the dashboard, including replaying the specific user interactions relevant to each step on the linked dashboard components, and displaying the explanatory title and short description as text overlays.

### RELATED APPLICATIONS

This application claims priority to U.S. Provisional Application Ser. No. 63/691,311, filed Sep. 5, 2024, entitled “Interactive Data Tour Creator for Dashboards,” and U.S. Provisional Application Ser. No. 63/694,784, filed Sep. 13, 2024, entitled “Interactive Data Tour Creator for Dashboards,” each of which is incorporated by reference herein in its entirety.

### TECHNICAL FIELD

The disclosed implementations relate generally to data visualization and more specifically to systems, methods and user interfaces for authoring interactive data tours for dashboards using generative artificial intelligence.

### BACKGROUND

Dashboards have become a ubiquitous tool in data analysis and reporting, widely used across various industries to present and interpret data visually. They help users quickly grasp complex information through charts, graphs, texts, user interface (UI) widgets, such as dropdowns, search bar, and other visual elements. Dashboards can include charts, texts, and UI widgets. The visual and interactive nature of dashboards make them powerful mediums for analyzing complex data in an accessible format. However, in practice, users often need guidance to use different components and functionalities of a dashboard, starting from understanding the functionality of data filters and buttons to understanding the context of the data and domain, interpreting charts, and learning various ways to interact with the dashboard.

Popular guidance strategies for dashboards face several practical challenges. Dashboard creators invest significant time understanding users and creating guidance materials, often navigating multiple authoring tools. With large-scale dashboards and diverse user bases, maintaining guidance becomes burdensome, particularly when dashboards require frequent updates. While dashboard creators prefer dynamic and interactive guidance that demonstrates usage scenarios, they often default to static documentation due to time and resource constraints. This leads to guidance materials that may be skipped or ignored by users.

### SUMMARY

Accordingly, there is a need for systems and methods to aid dashboard authors in composing their visualizations. The present disclosure describes systems and methods that provides assistance to dashboard authors in authoring interactive data tours. Data tours are interactive step-by-step data-driven content that walk the users through different charts and UI components of a dashboard to communicate interesting insights or to explain the purpose and usage scenario of the dashboard. The communication intent for a data tour may be selected from predefined options including data facts/insights for highlighting interesting data points, interaction guide for demonstrating dashboard usage, and dashboard composition/semantics for explaining chart interpretations. Authors may also provide custom generation instructions to tailor content generation. The system supports regenerating content for individual steps when intents change, positioning explanatory overlays near interaction points, and adding non-interactive contextual steps to enhance the narrative flow.

These systems and techniques help dashboard creators rapidly author guidance that is interactive and engaging (i.e., interactive data tours), instead of static (e.g., technical documents). Some implementations, given a communication intent, capture and convert user interactions into step-by-step data tours and generate appropriate textual explanation for each step. Some implementations provide a range of authoring features for authors to refine textual components of the data tours, e.g., edit the content directly; regenerate content for individual steps; add/remove/reorder steps; refine communication intent for the whole tour or individual steps. Some implementations render the data tour, by replaying the specific interactions relevant to a step in the dashboard via an interactive step-by-step overlay on the dashboard, featuring explanatory text.

According to one aspect, a computer-implemented method is provided for creating and presenting interactive data tours for dashboards. The method includes receiving a communication intent for a data tour of a dashboard. The method also includes recording user interactions with components of the dashboard. The method also includes generating a sequence of steps for the data tour based on the recorded user interactions. Each step is linked to one or more dashboard components. The method also includes generating, using a Large Language Model (LLM), an explanatory title and a short description based on the linked dashboard components and the communication intent, for each step in the sequence of steps. The method also includes presenting an interface for editing the data tour. The method also includes receiving edits to the data tour through the presented interface. The method also includes storing the edited data tour. The method also includes, in response to a request to play the data tour, presenting the data tour as an interactive step-by-step guide overlaid on the dashboard, including for each step: replaying the specific user interactions relevant to the step on the linked dashboard components; and displaying the explanatory title and short description as text overlays.

In some implementations, the interface enables editing of the explanatory title and short description for each step.

In some implementations, the interface enables regeneration of content for individual steps using the LLM.

In some implementations, regeneration requires selection of a content type from predefined options and optional generation instructions.

In some implementations, the interface enables addition, removal, and reordering of steps in the sequence, including providing insertion points in the data tour.

In some implementations, the interface enables refinement of the communication intent for the entire data tour or individual steps.

In some implementations, changing the communication intent at the tour level regenerates all steps, and changing the intent at the step level regenerates only the corresponding step

In some implementations, recording user interactions comprises capturing at least one of: mouse clicks, keyboard inputs, scroll events, and changes to dashboard settings or filters.

In some implementations, generating the sequence of steps includes analyzing the recorded user interactions to identify distinct actions or sets of actions, and creating a step for each distinct action or set of actions.

In some implementations, actions that derive from the same interaction event are grouped within the same step.

In some implementations, generating the explanatory title and short description using the LLM includes providing the LLM with context about the dashboard, the linked components, the recorded user interactions, and the communication intent, and receiving generated text from the LLM based on the provided context.

In some implementations, the method further includes automatically generating multiple data tours for the dashboard based on different communication intents, and providing an interface for a user to select and customize the generated data tours.

In some implementations, the method further includes receiving a selection of the communication intent, wherein the communication intent is selected from a group consisting of: data facts/insights comprising interesting data highlights, interaction guide comprising how to use/interact with the dashboard, and dashboard composition and semantics comprising how to read/interpret the dashboard.

In some implementations, the group further includes other type, which provides the ability to tell a different story than the data facts/insights, interaction guide, and dashboard composition and semantics, wherein the other type of communication intent requires additional instructions to be provided by an author.

In some implementations, the method further includes providing an option for authors to select or filter what actions are meant to be captured during the recording of user interactions.

In some implementations, the interface for editing the data tour includes options for: (i) editing global features including changing tour type, providing custom generation instructions, and editing tour title, (ii) editing step features, (iii) capturing or inserting new interactive steps, (iv) adding new non-interactive steps, and (v) deleting steps.

In some implementations, presenting the data tour includes providing replay options for playing (i) a whole tour, and (ii) an individual step.

In some implementations, the text overlays are positioned close to where the interaction took place for interactive steps and at the center of the dashboard for non-interactive steps.

In some implementations, the communication intent is interaction guide, and the method further includes: tailoring the recorded user interactions to demonstrate basic dashboard navigation and functionality, generating explanatory titles and descriptions that focus on how to use and interact with different dashboard components, including options in an editing interface to add additional explanations for specific dashboard interactions, and enhancing the interactive step-by-step guide with highlighted UI elements to guide users through various interaction points.

In some implementations, the communication intent is data facts/insights, the method further includes: tailoring the recorded user interactions to reveal key data insights or trends; generating explanatory titles and detailed descriptions that highlight interesting data points; including options in an editing interface to add statistical context or comparative data; and enhancing the interactive step-by-step guide with data visualizations that emphasize notable facts or insights.

In some implementations, the communication intent is dashboard composition and semantics, the method further includes: tailoring the recorded user interactions to showcase different parts of the dashboard and their meanings; generating clear, descriptive titles and explanations for each dashboard component; providing options in an editing interface to add detailed interpretations of charts, graphs, and other data representations; and providing overlays in the interactive step-by-step guide that explain how to read and interpret different elements of the dashboard.

In some implementations, the communication intent is other than interaction guide, data facts/insights, and dashboard composition and semantics, the method further includes: prompting to provide additional instructions for the desired narrative or explanation; tailoring the recorded user interactions based on the additional instructions; generating custom titles and descriptions that align with an intended story or explanation; providing options in an editing interface to refine the custom narrative and add contextual information; and enhancing the interactive step-by-step guide with features that support a unique storytelling approach.

In some implementations, the method further includes: providing an interface to switch between different communication intents; automatically adjusting the focus and content of the data tour based on the selected communication intent; and providing intent-specific editing options and enhancements for each type of communication intent.

In another aspect, a computer system for generating interactive data visualizations and textual content includes one or more processors and memory. The memory stores one or more programs configured for execution by the one or more processors, and the one or more programs include instructions to perform any of the methods described herein.

In another aspect, a non-transitory computer readable storage medium stores one or more programs configured for execution by a computer system having a display, one or more processors, and memory. The one or more programs include instructions to perform any of the methods described herein.

Both the foregoing general description and the following detailed description are exemplary and explanatory and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide capabilities for authoring interactive data tours for dashboards using generative artificial intelligence, reference should be made to the Description of Implementations below, in conjunction with the following drawings in which like reference numerals refer to corresponding parts throughout the figures.

FIG. 1 is a block diagram of an example system for interactive data tour creator dashboards, according to some implementations.

FIG. 2 shows an example graphical user interface for interactive data tour creation, according to some implementations.

FIG. 3 shows a schematic diagram of an example process for recording and generating steps for data tours, according to some implementations.

FIG. 4 shows an example editing interface, according to some implementations.

FIG. 5 shows an example replay interface, according to some implementations.

FIGS. 6A-6AG illustrate an example data tour creation and refinement process, according to some implementations.

FIG. 7 is an example process flow for authoring dashboard guidance using a system, according to some implementations.

FIG. 8 shows another example process flow for authoring dashboard guidance using a system, according to some implementations.

FIGS. 9A and 9B show another example process flow for authoring dashboard guidance using a system, according to some implementations.

FIG. 10 shows example JSON formatted objects for storing dashboard metadata and interactions associate with a dashboard, according to some implementations.

FIG. 11 shows another example editing interface for authoring dashboard guidance using a system, according to some implementations.

FIGS. 12A and 12B show an example dashboard tour generated by a system, according to some implementations.

FIGS. 13A and 13B show a block diagram of an example computing device for interactive data tour creation for dashboards, according to some implementations.

FIG. 14 is a flowchart of an example method for data tour creation for dashboards according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

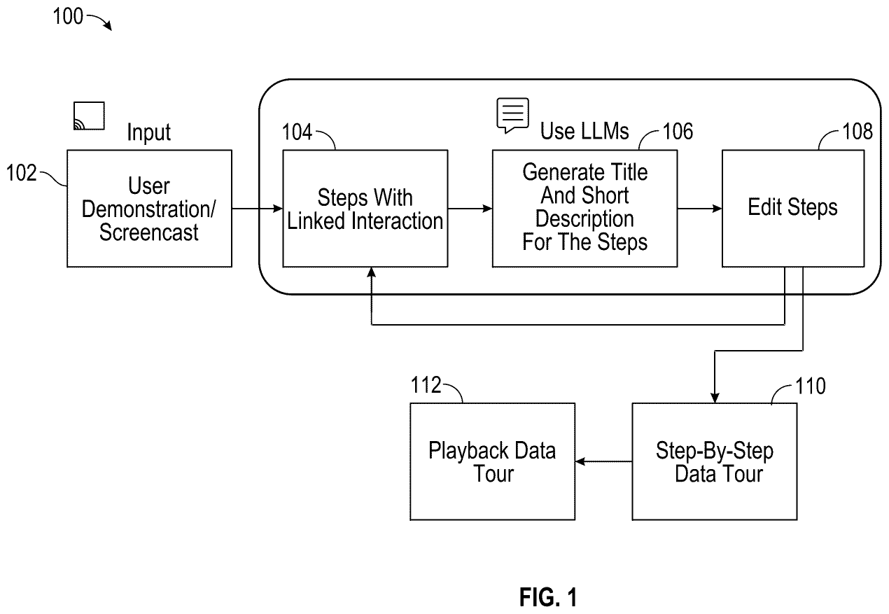

FIG. 1 is a block diagram of an example system 100 for interactive data tour creator dashboards, according to some implementations. Data tours are interactive step-by-step data-driven content that walk the users through different charts and UI components of a dashboard to communicate interesting insights or to explain the purpose and usage scenario of the dashboard. Some implementations provide an application 102 to demonstrate a data tour and/or screencast. Using some implementations of the system 100, a dashboard creator can create a data tour by directly interacting with the dashboard and recording the interactions. The system captures (104) the recorded interactions and generates steps for the tour by linking the dashboard components with the steps. Some implementations of the system use a Large Language Model (LLM) to generate (106) explanatory titles and short descriptions for each step of the data tour. After the initial data tour is created, the system provides features 108 to edit and/or refine the individual steps. In some implementations, the system generates a step-by-step data tour 110, based on the steps, titles, and/or short descriptions, and/or the interactions. In some implementations, the system plays back (112) the data tour as a step-by-step guide 110, with each step showing the specific interactions relevant to the step along with the explanatory title and description as text overlays. This process results in multiple insight-oriented data tours with clear links to the dashboard components that authors can easily reorganize and update.

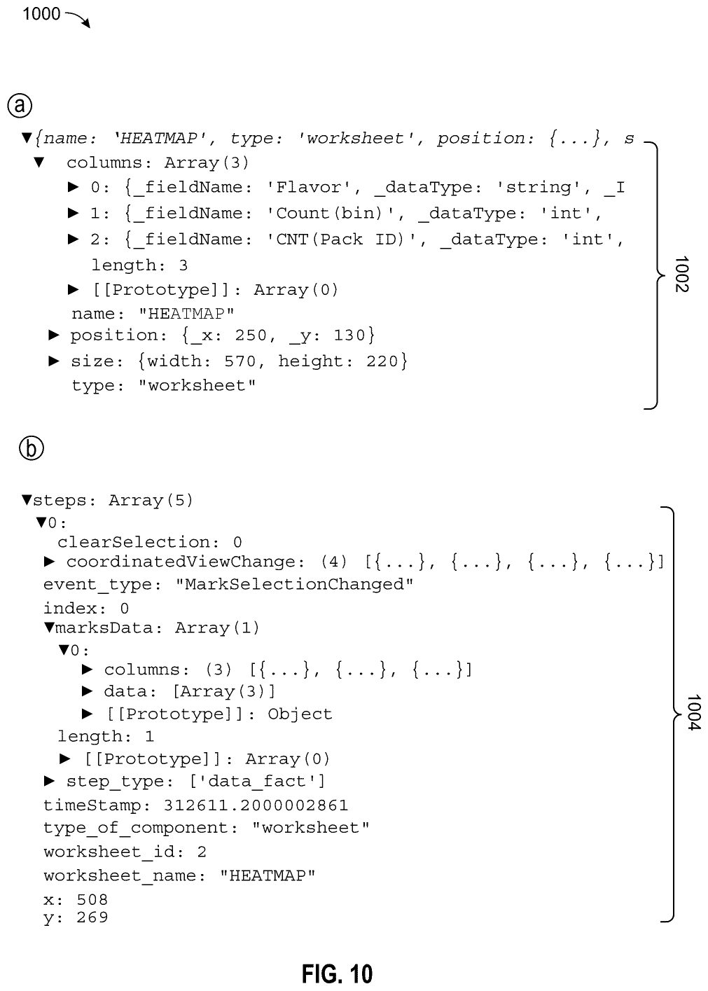

In some implementations, a dashboard (e.g., a Tableau dashboard) includes multiple zones, where each zone contains elements, such as charts, images, UI widgets, or texts. Upon loading a dashboard, the system extracts metadata about each zone using an embedding API (e.g., Tableau Embedding API). For chart zones, the system extracts encoding information and marks. For text zones, the raw text data is extracted and used as context for prompting language models. This metadata is stored in JSON format and used in the tour creation process (e.g., discussed below in FIG. 10).

Some implementations provide a framework, such as the example system 100, in which, given a communication intent, the system captures and converts user interactions into step-by-step data tours and generates appropriate textual explanation for each step. The system provides a range of authoring features to refine textual components of the data tours, such as for editing the content directly, for regenerating content for individual steps, adding, removing, and/or reordering steps, and/or for refining communication intent for the whole tour and/or individual steps. The system renders the data tour, by replaying the specific interactions relevant to a step in the dashboard via an interactive step-by-step overlay on the dashboard, featuring explanatory text.

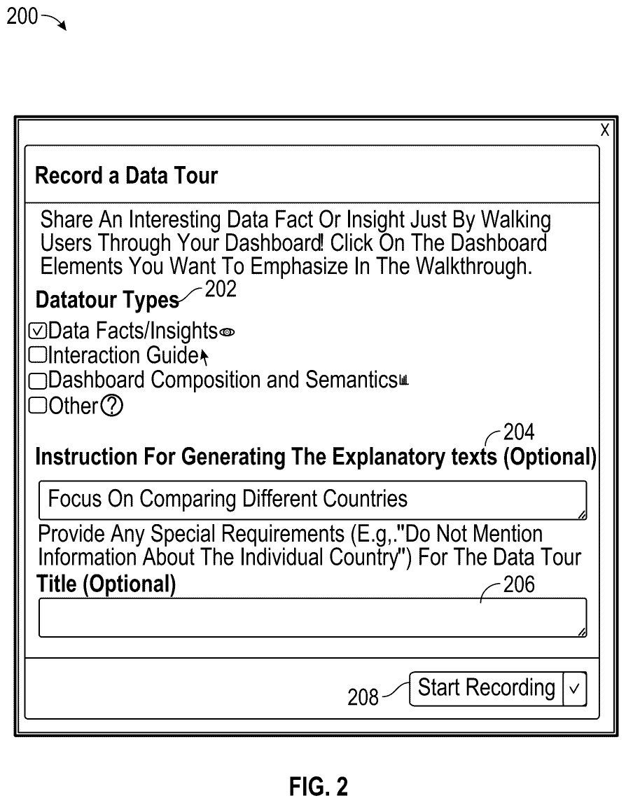

FIG. 2 shows an example graphical user interface 200 for interactive data tour creation, according to some implementations. Using the interface, a dashboard author can provide a communication intent (sometimes referred to as a data tour type). Some implementations provide options 202 for data facts/insights, interaction guide, dashboard composition and semantics, and other. Some implementations provide an option 204 to provide instructions for generating text (e.g., focus on comparing different countries, negative limitations, such as do not mention information about the individual country for data tour or a step therein, and so on). Some implementations provide an option 206 to provide an optional title 206. Some implementations provide an optional affordance 208 to start recording a data tour. Some implementations capture and convert user interactions into step-by-step data tours and/or generate appropriate textual explanation for each step.

Communication intent pertains to the kind of guidance the author wants to provide. Example communication intents include: (a) data facts/insights, which can include interesting data highlights; (b) interaction guide, which can include how to use/interact with the dashboard; (c) dashboard composition and semantics, which can include how to read/interpret the dashboard; and (d) other type, which provides authors the flexibility to tell a different story than the ones supported above. The other option may require additional instructions to be provided. A data tour of type data facts/insights, for example, highlights facts about the data in the dashboard. An interaction guide data tour can be used, for example, to show how to use the dashboard. A dashboard composition and semantics data tour can be used to provide, for example, information and instructions on how to read and interpret different components and visualizations in the dashboard. The other option can be provided for customization of an implementation. Some implementations capture author-performed action that takes place in a dashboard. This can include click actions (e.g., mark selection, filter selection, drag-drop, legend selection), and depending on the dashboard, potentially scroll actions, hover actions, and/or keyboard actions. Some implementations provide an option for authors to select/filter what actions are meant to be captured.

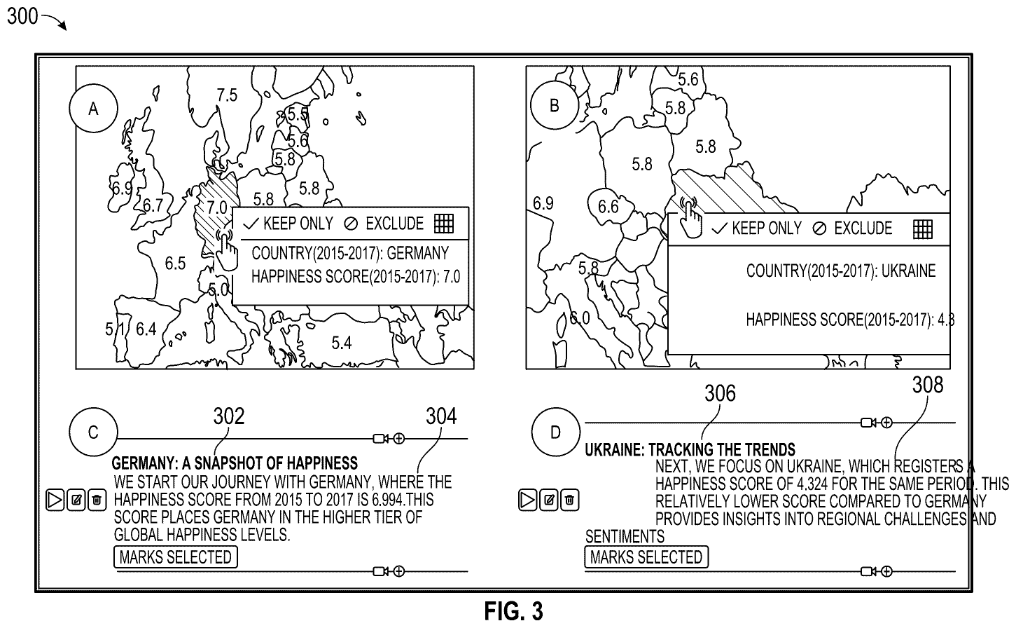

FIG. 3 shows a schematic diagram of an example process 300 for recording and generating steps for data tours, according to some implementations. A user can start a recording session (e.g., as described above in reference to FIG. 2) to capture interactions in a dashboard. In step A, for instance, the user clicks on Germany in a map to mark the interaction as a step in the data tour. In step B, for example, the user next clicks on Ukraine in a map to mark the interaction as the next steps. In step C, for example, after the recording session ends, the system automatically generates a title 302 and description 304 for the step. In step D, similarly, the system generates a title 306 and description 308 for the next step, and so on.

In some implementations, author-driven manipulation of the dashboard map to an interactive action, which can include action features, such as component that captured the click, the data item associated with a selected mark, and views that are filtered from a filter selection. Some implementations include access to the full context of these actions and respective features, and/or the actions and features are stored as part of the respective step.

In some implementations, the system captures the recorded interactions and generates steps for the tour by linking the dashboard components with the steps. An interactive action maps to a single step. Sometimes, multiple actions happen under the dashboard's hood from a single click, e.g., filtering across multiple views. Actions that derive from the same interaction event are grouped within the same step. These actions can be provided as part of the interactive action features. Some implementations convert the dashboard interaction into steps for the data tour. A new step can include, for example, a selection of a data point by clicking on a dashboard component such as charts or widgets. Since typically dashboards have multiple coordinated views, a selection in one chart can change other relevant views. Some implementations automatically combine such coordinated changes into a single step.

In some implementations, the system uses a Large Language Model (LLM) to generate explanatory titles and short descriptions for each step of the data tour. Some implementations fine-tune the LLMs on domain-specific data. Some implementations use a different LLM that has been trained on a specific data domain. As described above, data tours are interactive step-by-step data-driven content that walk the users through different charts and UI components of a dashboard to communicate interesting insights or to explain the purpose and usage scenario of the dashboard. In some implementations, the system has access to the full underlying context of the dashboard, including information on the data, calculations, metrics, and associated documentation. In some implementations, the system provides relevant context in a prompt to an LLM for generating textual content.

Some implementations use GPT-4o for generating the initial title and description for the steps. In FIG. 3, steps C and D illustrate two examples. The following is a sample prompt that can be used to generate the text:
“The following is the JSON object for a data tour, outlining the steps from the data tour—<JSON Object>. The individual events are recorded in the ‘steps’ key. The ‘coordinatedView Change’ key in each step represents changes to the coordinated views of the dashboard as a result of the event.
Generate a title and short description for each event/step in natural language. Craft a story out of the steps and write the title and description accordingly.
Return in the following JSON format {‘title’: <tour title>, ‘steps’: <collection of event object with two keys, ‘title’ and ‘description’>}. Finally, the user has provided the following custom instruction—<Instruction>. Consider it while creating the content for the tour.”

After the initial data tour is created, the system provides features to edit and refine the individual steps, according to some implementations. This can include features, such as (a) editing global features (e.g., change tour type, custom generation instructions, edit tour title), (b) editing step features, (c) capturing/inserting new interactive steps, (d) adding new non-interactive step, and (e) deleting step. Editing features can be accessible from a side panel. Some implementations provide options to edit and/or refine the content for the steps.

In some implementations, each step in the data tour maintains its own communication intent, which may differ from the tour-level intent. When an author changes a step's intent, the system regenerates content specifically for that step while preserving the overall tour narrative. The system supports inserting non-interactive steps between existing steps to provide context, transitions, or summaries. Steps can be reordered through the interface, with the system maintaining proper sequencing of interactions and coordinated view changes. Authors may provide step-specific instructions to the language model to fine-tune content generation without affecting other steps.

In some implementations, the interface provides multiple options for refining data tours. Authors can edit global settings including changing tour type, providing custom generation instructions, and editing tour title. For individual steps, the interface enables changing intent, regenerating content, and adding custom instructions. Authors can capture new interactive steps at any point in the sequence or add non-interactive steps for context. The system provides playback options for both complete tours and individual steps. Text overlays are strategically positioned near interaction points for interactive steps and centrally for non-interactive steps.

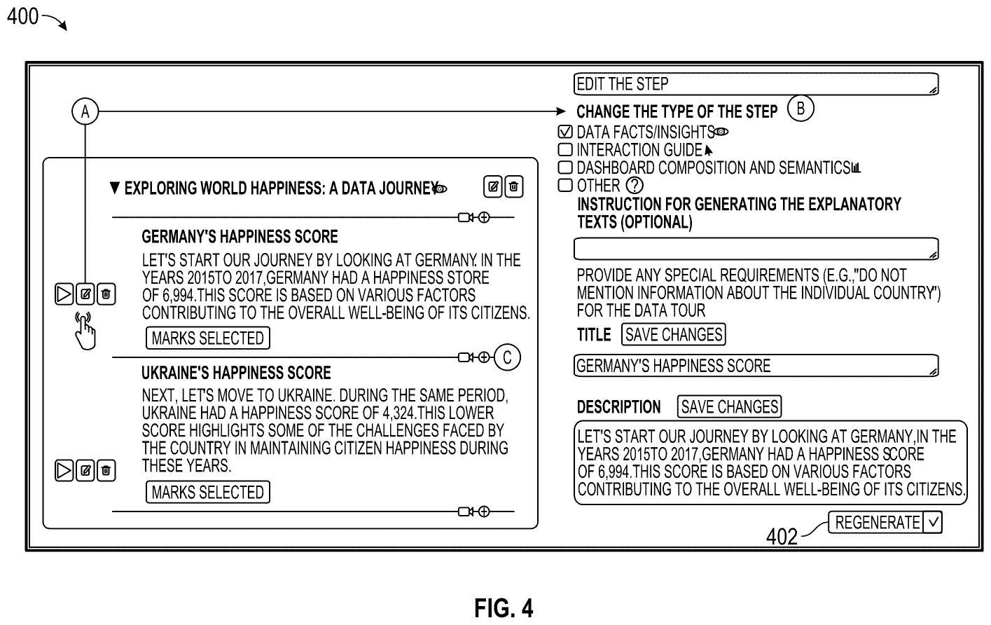

FIG. 4 shows an example editing interface 400, according to some implementations. The interface 400 can be used to change textual component and/or type of a step. In step A, for example, the data tour is presented as a step-by-step guide. The user chooses the edit feature to edit the first step. In step B, the system provides options to revise the generated content. This can include changing type of steps, instructions for generating texts, title, and/or description, similar to the interface described above in reference to FIG. 2. The user can manually edit the title for the step. The user can also change the type of the step and provide special instruction to the LLM for regenerating the content. In step C, the system provides an option to record new steps between the existing steps or manually add a new step in between the steps. The user can, for instance, delete any steps at this phase. The system also provides an affordance 402 to regenerate the steps.

Some implementations provide a range of authoring features for authors to refine textual components of the data tours. This can include, for example, editing the content directly, direct manual editing (e.g., tour title, step title, step content), and/or regeneration (e.g., after changing tour/step type, or providing custom generation instructions). In some implementations, the system provides a range of authoring features for authors to refine textual components of the data tours, for example, regenerate content for individual steps. For example, a user can select a content type (e.g., a content type out of a predetermined number of options, e.g., 4), and can provide optional generation instructions. In some implementations, the system provides a range of authoring features for authors to refine textual components of the data tours, for example, for adding, removing, and/or reordering steps. Some implementations provide insertion points in the data tour. Some implementations allow reordering. Some implementations provide a range of authoring features for authors to refine textual components of the data tours, for example, for refining communication intent for the whole tour or individual steps. The communication intent can be re-picked from the same list used to generate the tour. For changing intent at a tour level, all the steps can be regenerated. For changing intent at a step level, only the corresponding step gets regenerated.

In practice, users often need guidance to use different components and functionalities of a dashboard, starting from understanding the functionality of data filters and buttons to understanding the context of the data and domain, interpreting charts, and learning various ways to interact with the dashboard. Accordingly, in some implementations, the author can identify and/or select appropriate interactions, prioritize dashboard navigation and functionality, for new user onboarding. The author can define and/or represent specific workflows or tasks.

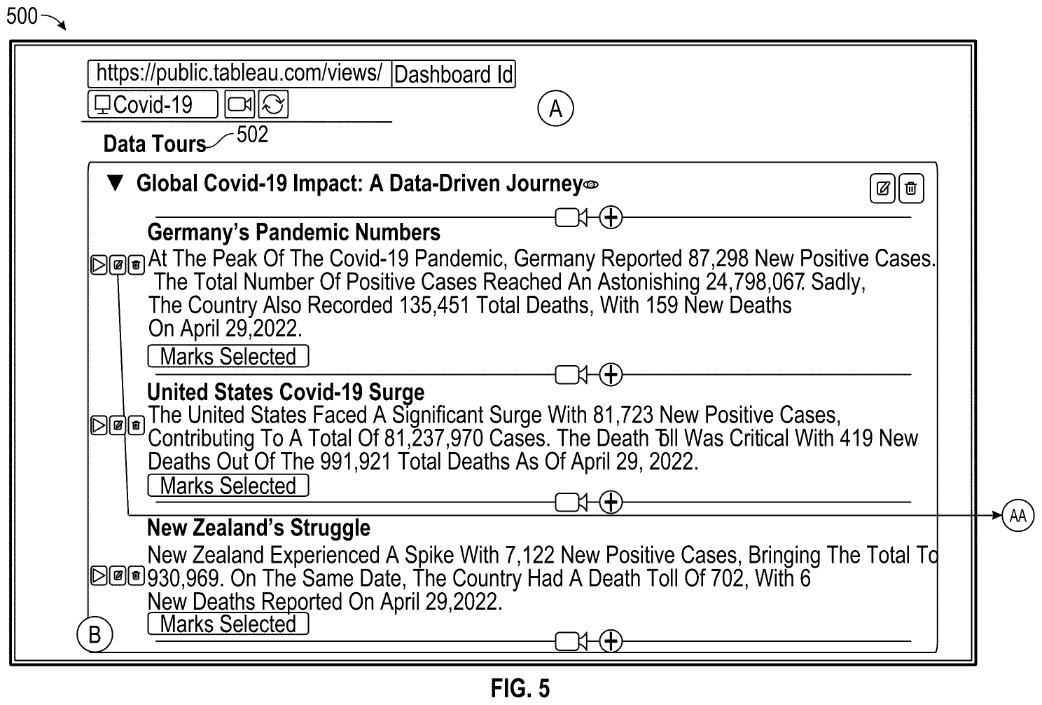

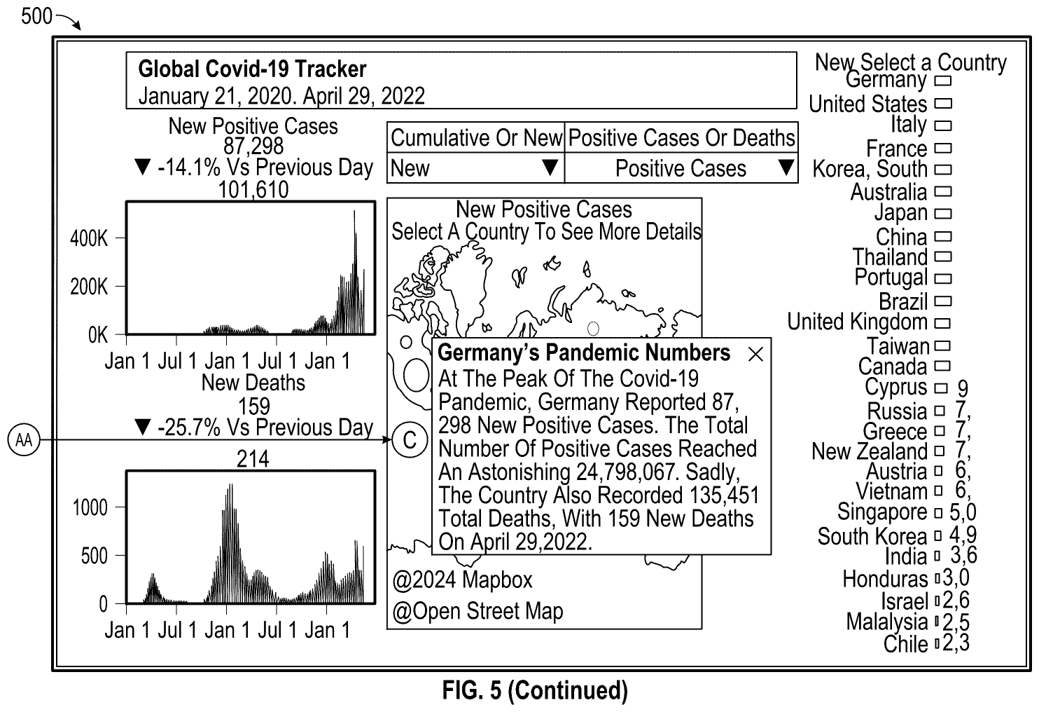

FIG. 5 shows an example replay interface 500, according to some implementations. The graphical user interface can be used to play back the data tour as a step-by-step guide, with each step showing the specific interactions relevant to the step along with the explanatory title and description as text overlays. The system allows, as shown in A, a user to provide the link to any dashboard or use any of the preloaded dashboards (e.g., dashboards stored and retrieved by the system prior to the play back or replay interface 500). As shown in B, some implementations provide example data tours that are available. Selecting one of the tours 502 shown in B leads to C, which shows a step replayed in the interface with the selected marks highlighted (Germany in the map) and title and description placed as an overlay. C shows a step, titled Germany's Pandemic Numbers, replayed in the interface with the selected mark highlighted (Germany in the map) and title and description placed as an overlay. Some implementations provide multiple replay options, for instance an option to play the whole tour, an option to play an individual step, an option to a set of steps, and so on. Some implementations provide content overlays, positioned close to where the interaction took place (for interactive steps) or at the center of the dashboard (for non-interactive steps). Interactive and non-interactive steps can be rendered differently. The example interface 500 can be used for replaying a data tour. Some implementations show the data tour encapsulated in a collapsible accordion. The tour has a title and options to edit the tour. Some implementations present the steps as a list where each step is represented in a separate row. Some implementations allow the dashboard creator to verify the data tour by replaying the data tour in the dashboard. On replaying a step, some implementations show the selected marks from the recorded interaction. The explanatory title and description is shown as an overlay, close to the place of interaction as shown in FIG. 5 (C), according to some implementations.

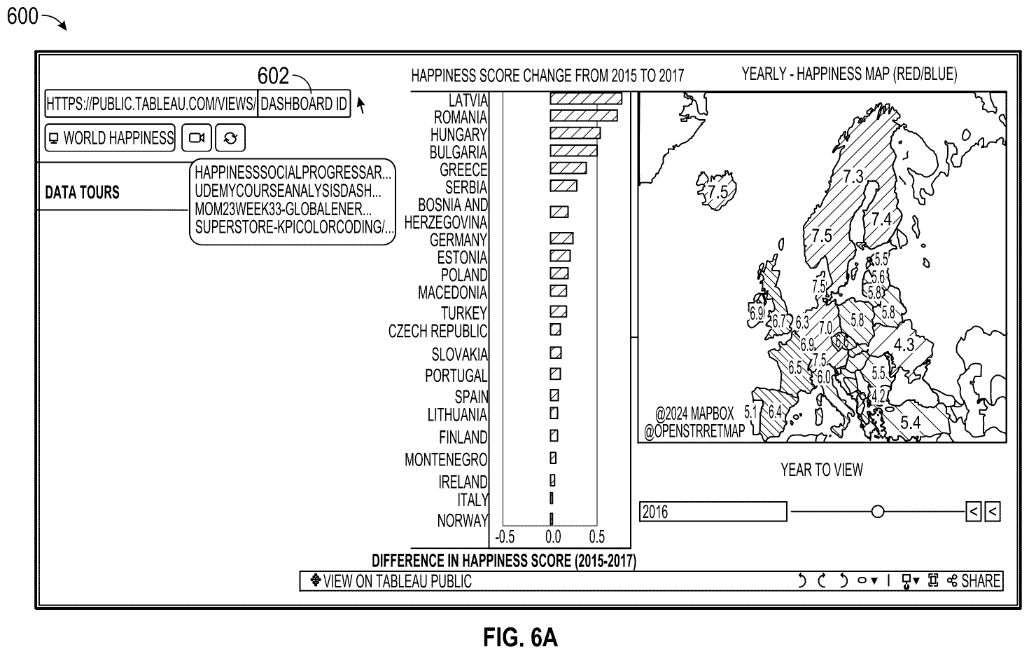

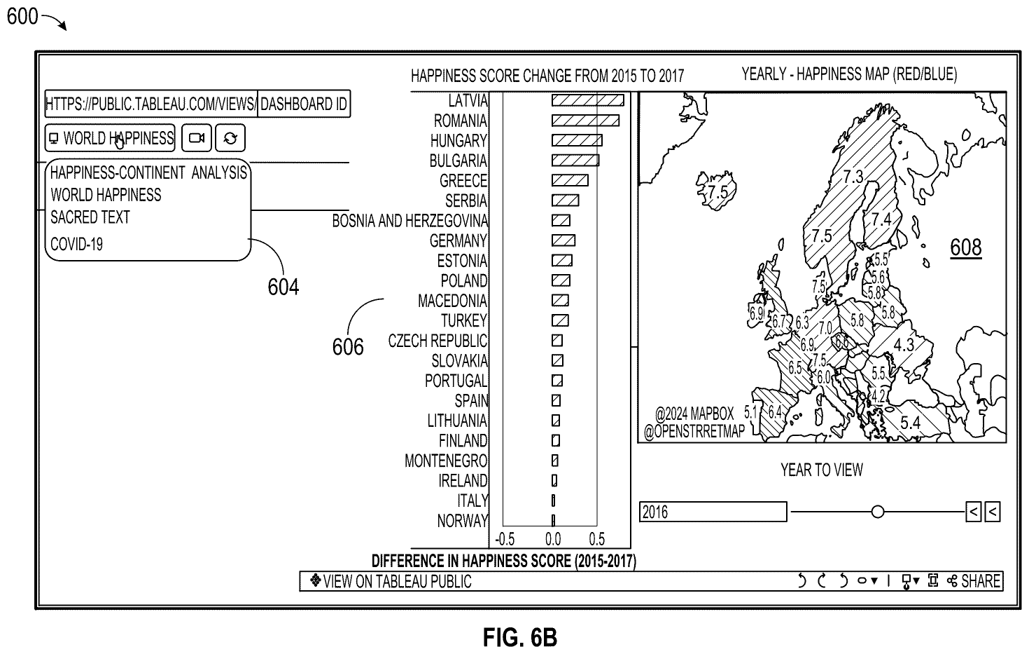

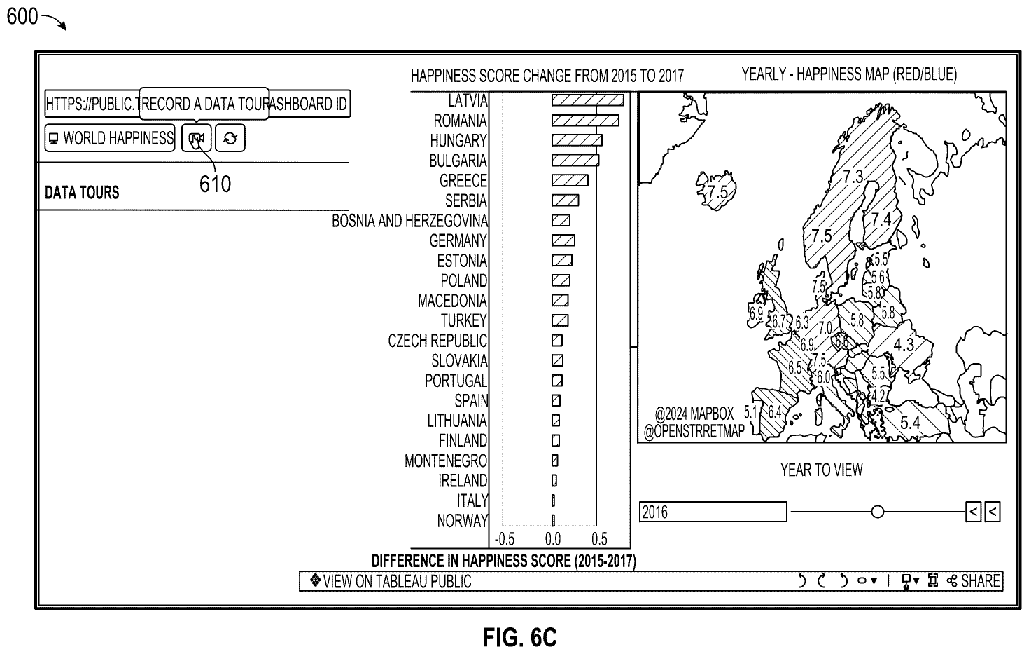

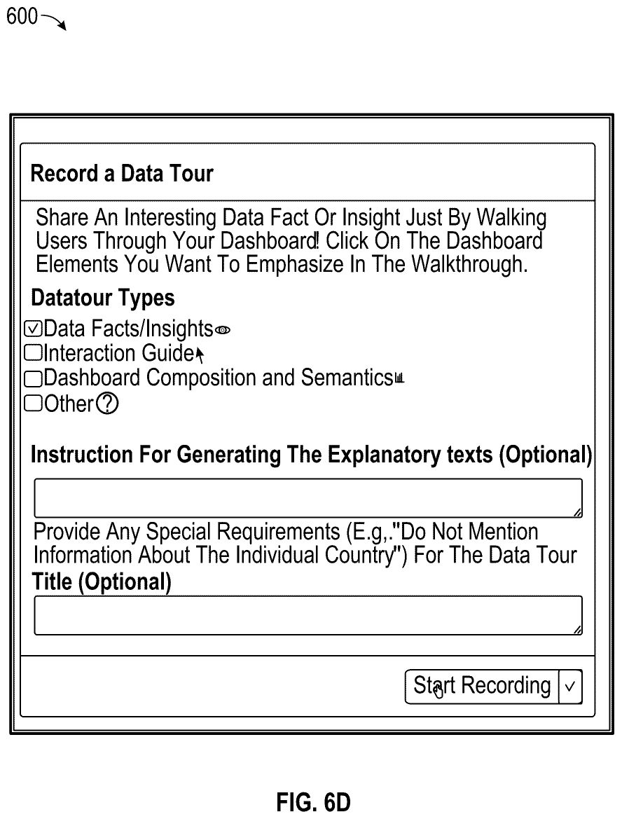

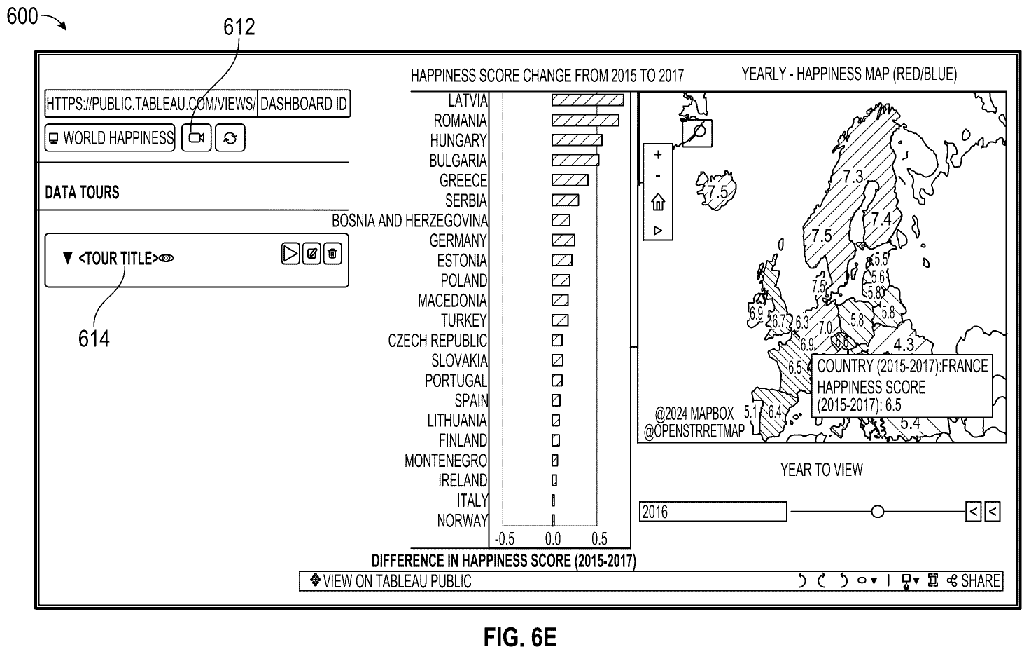

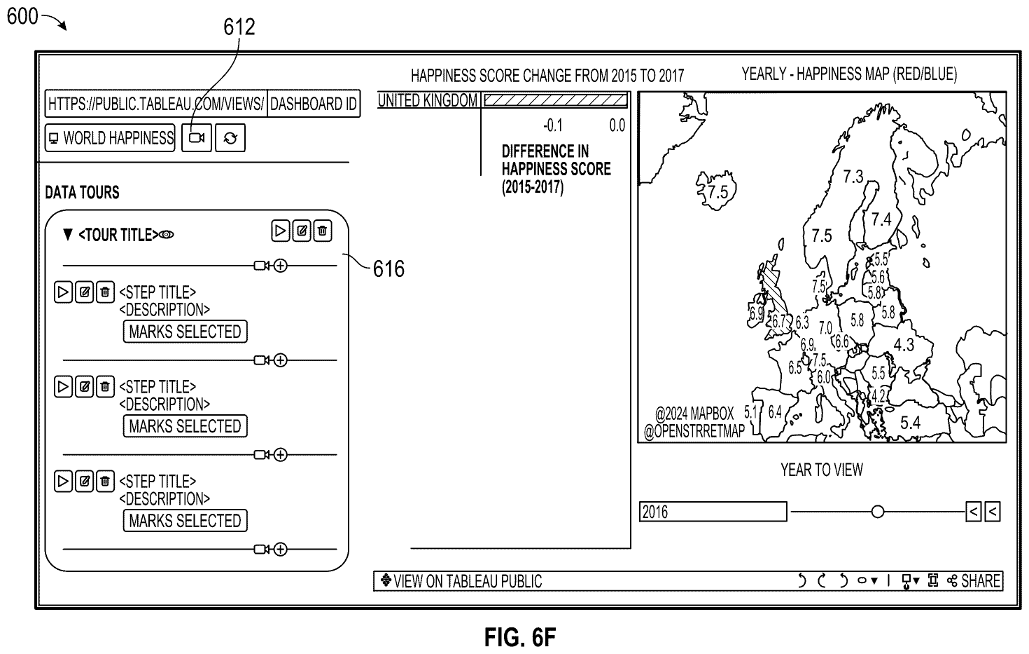

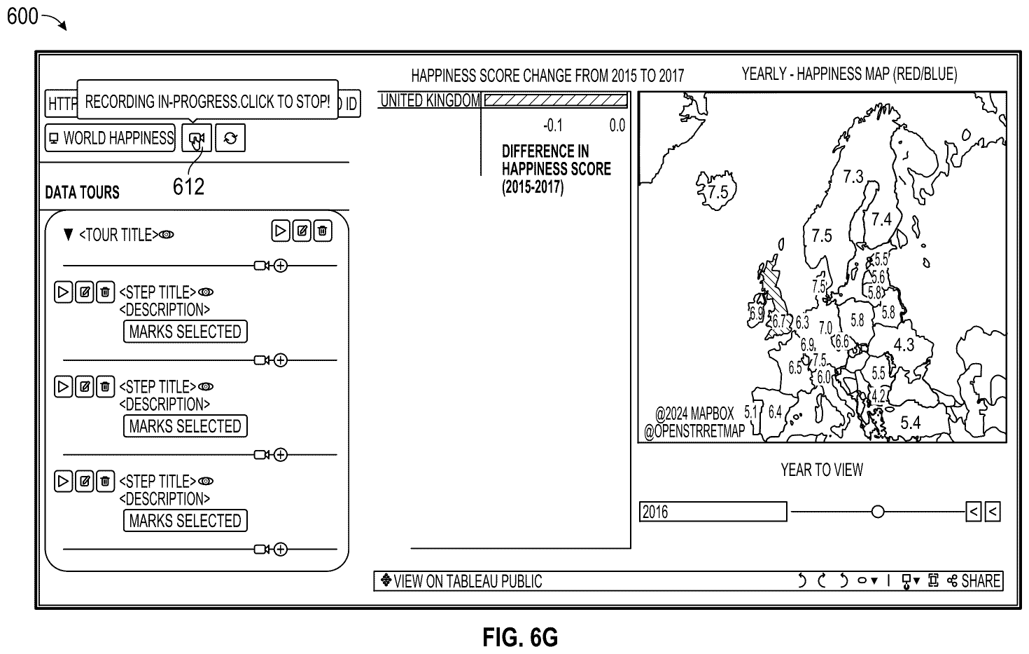

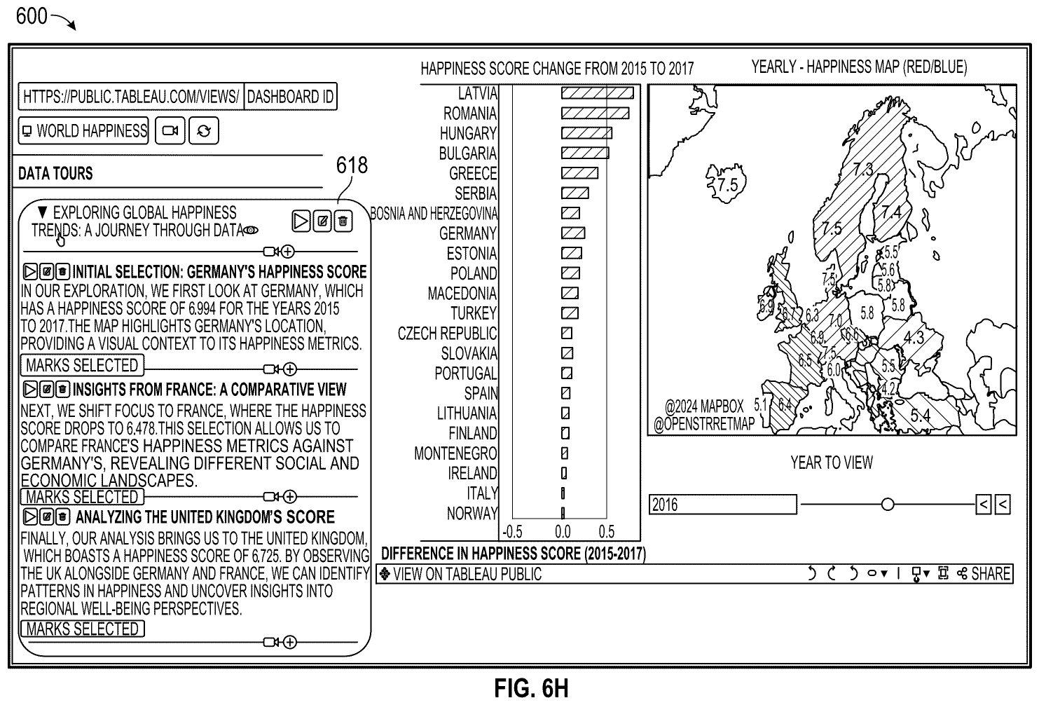

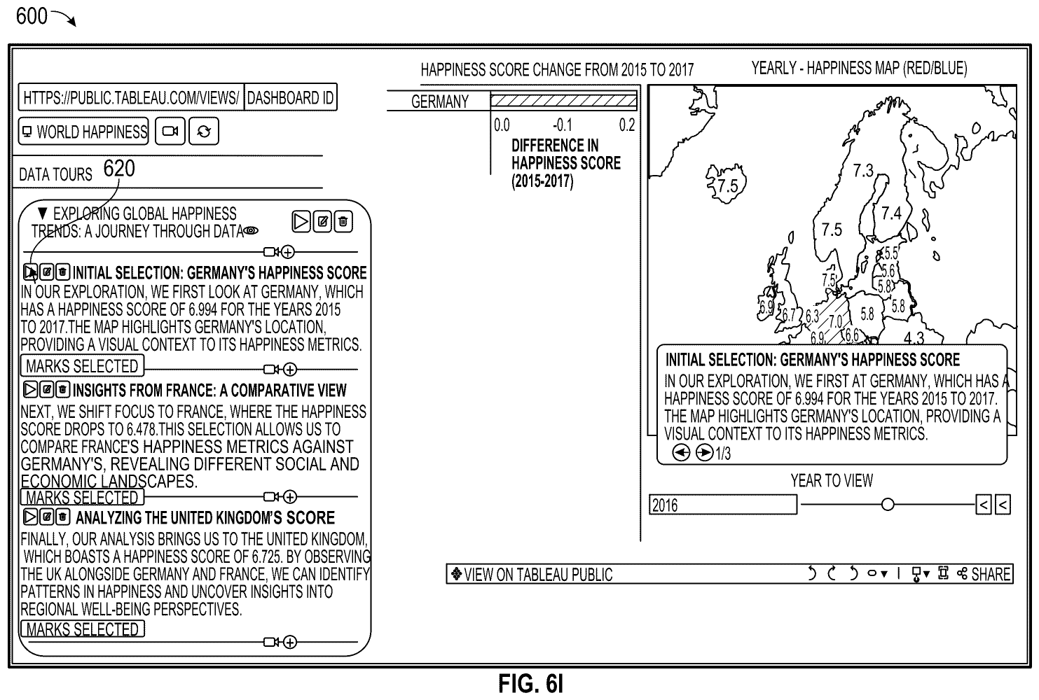

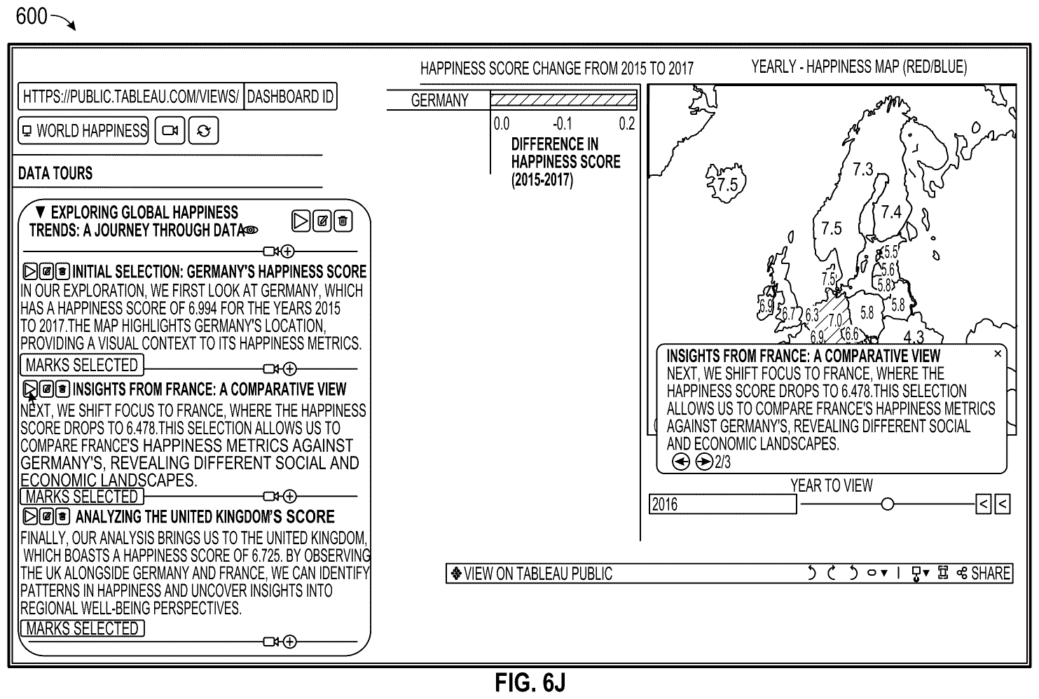

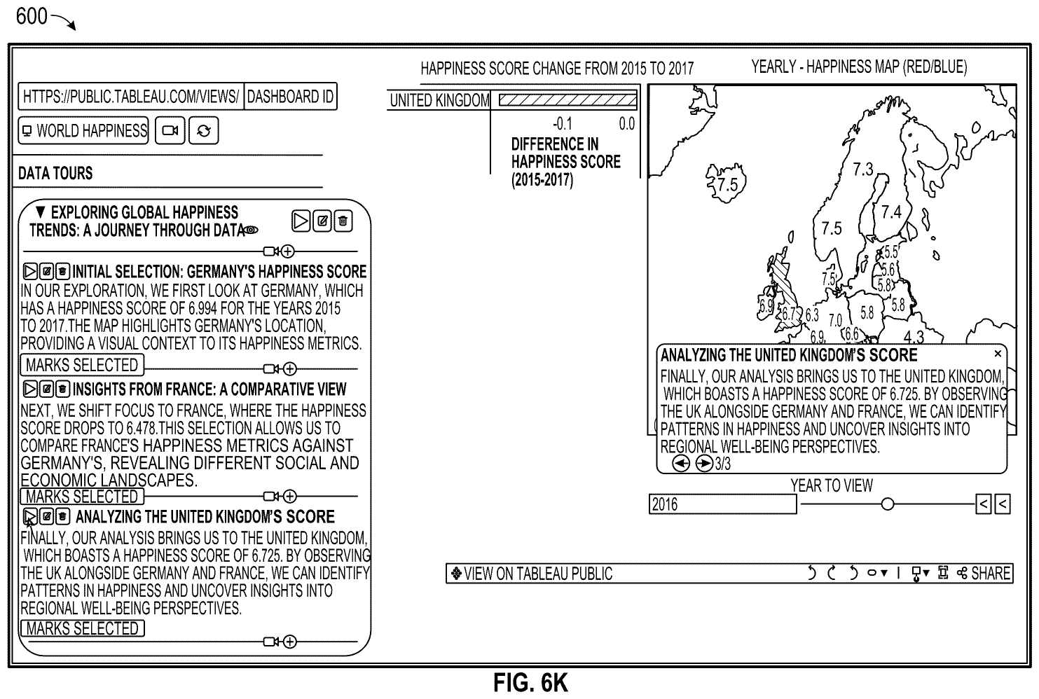

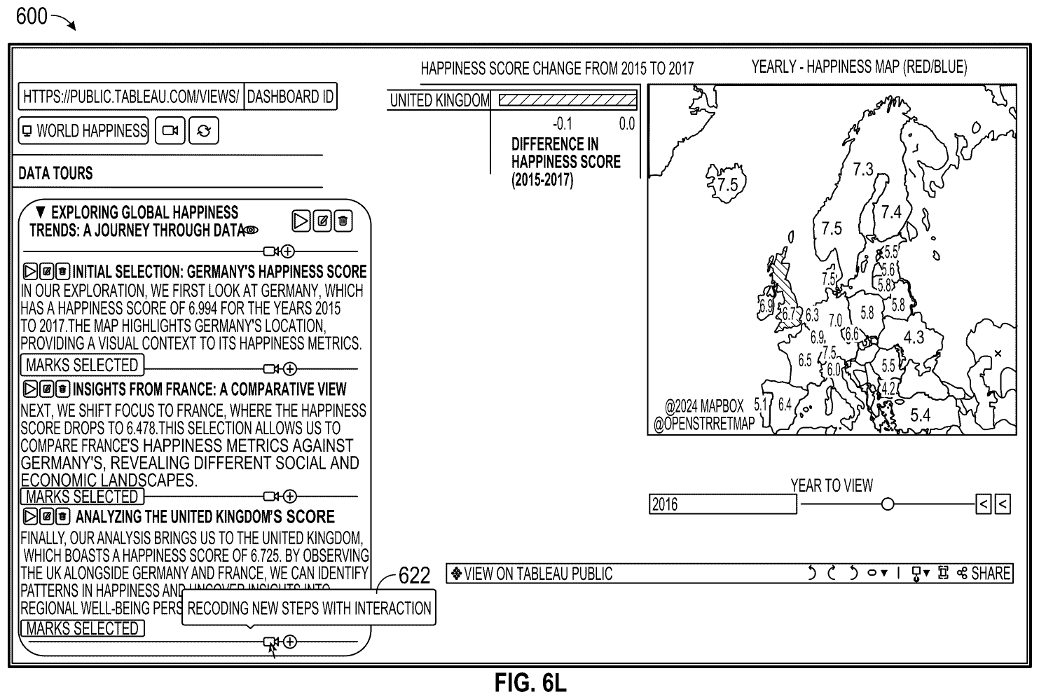

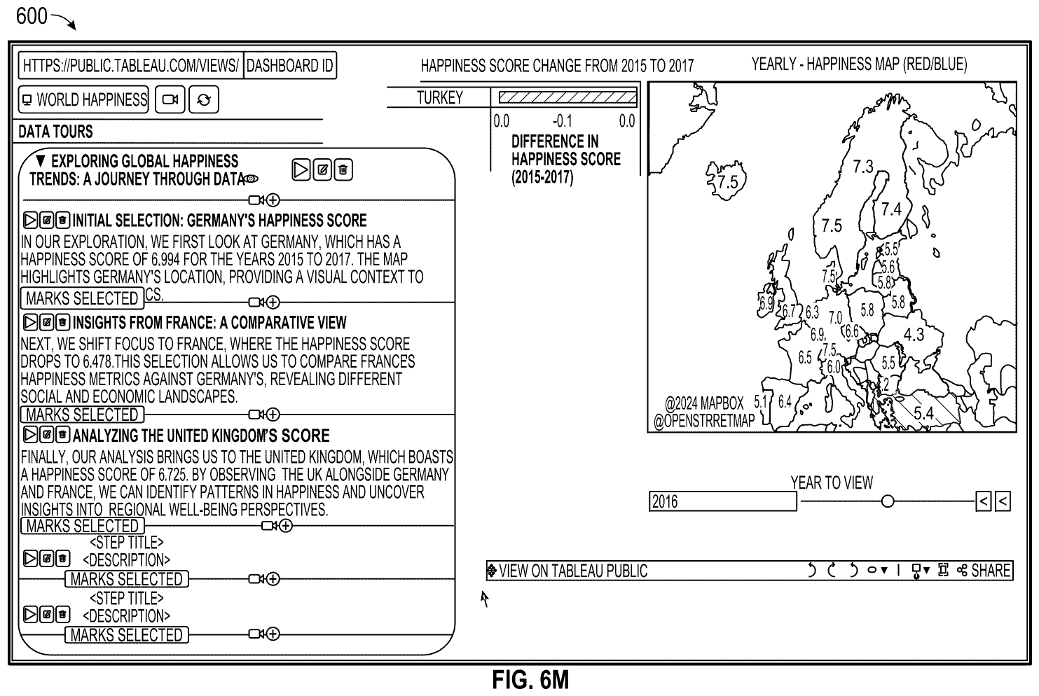

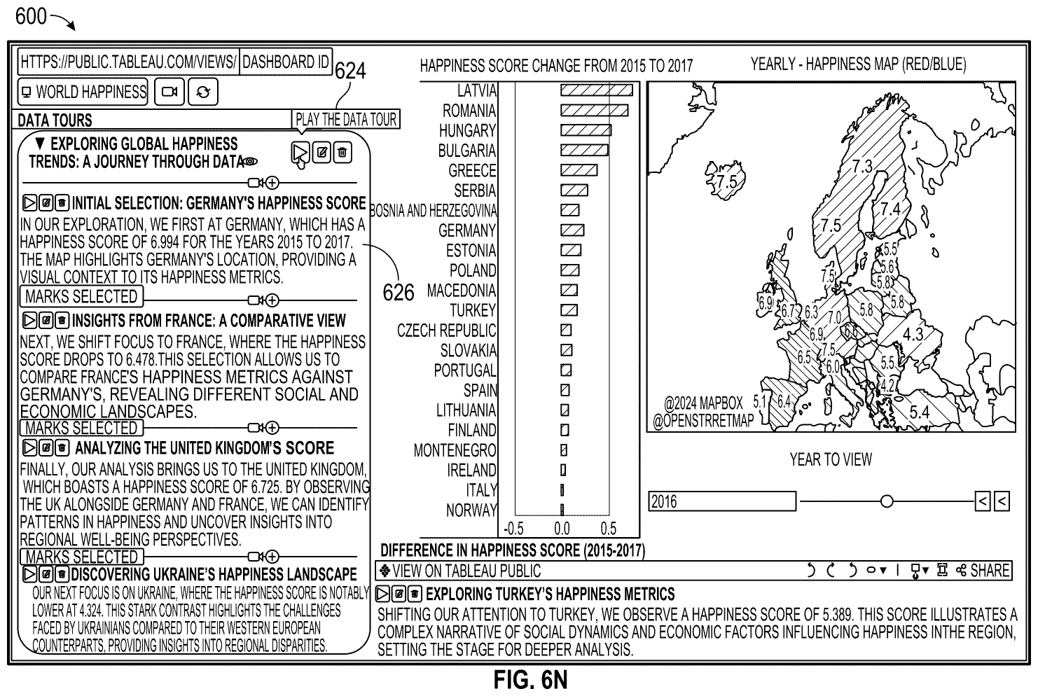

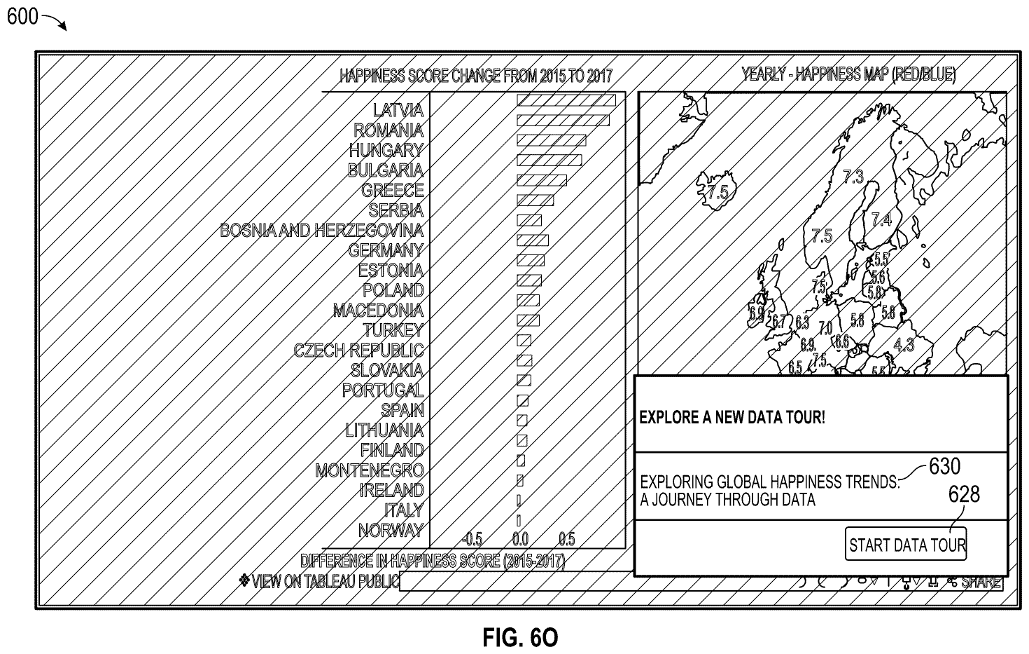

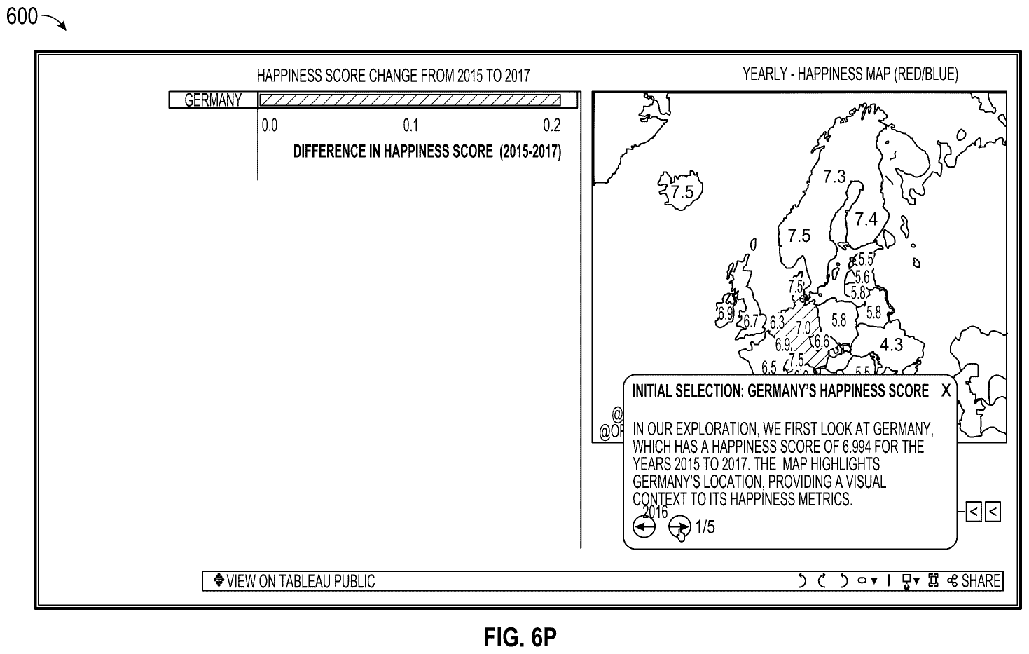

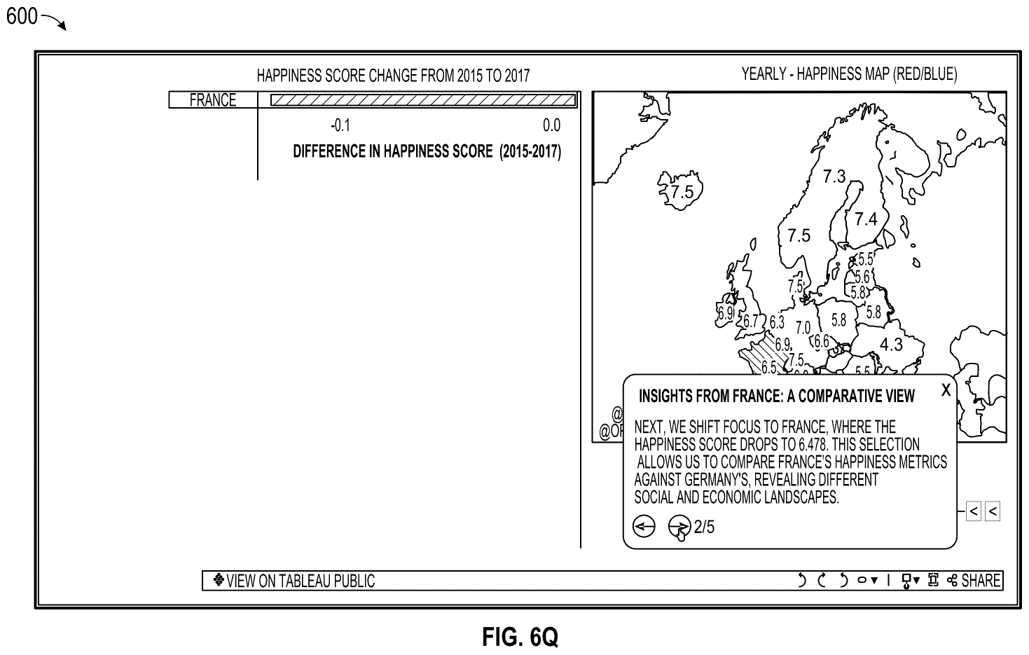

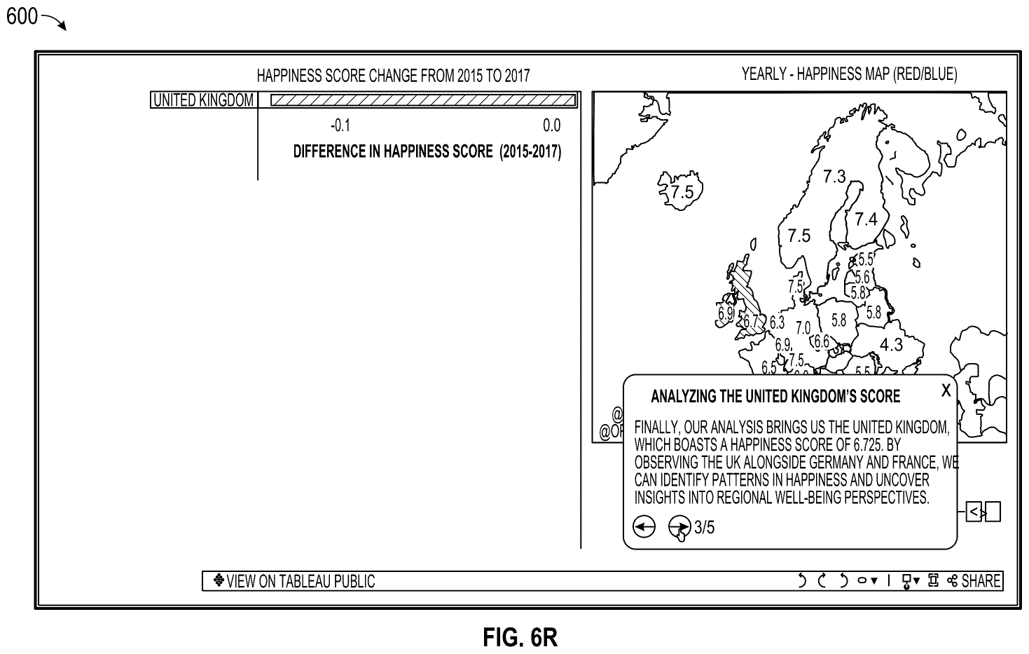

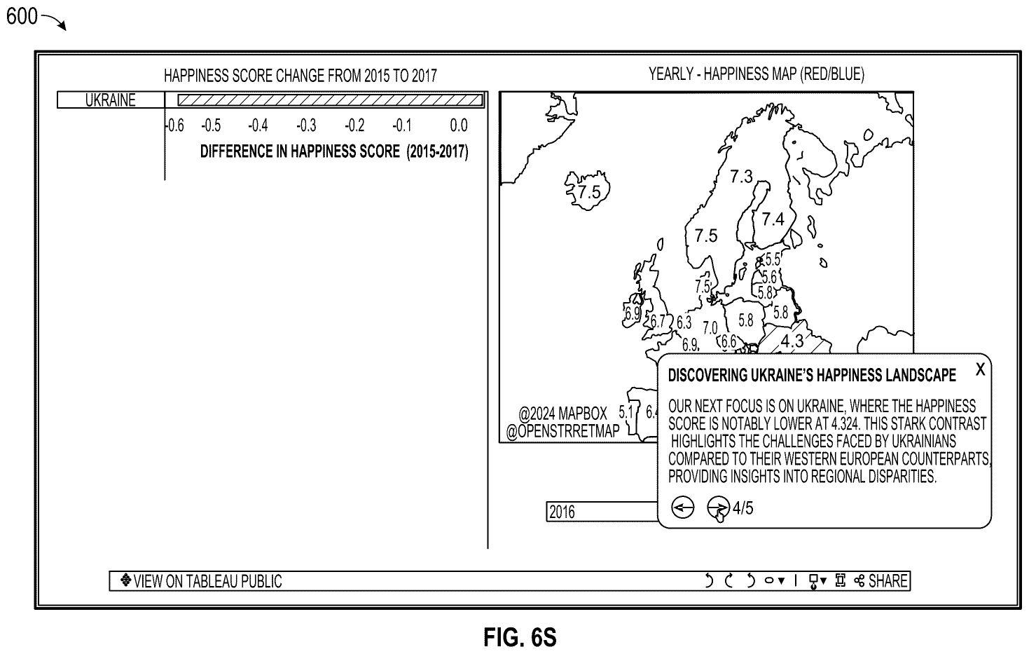

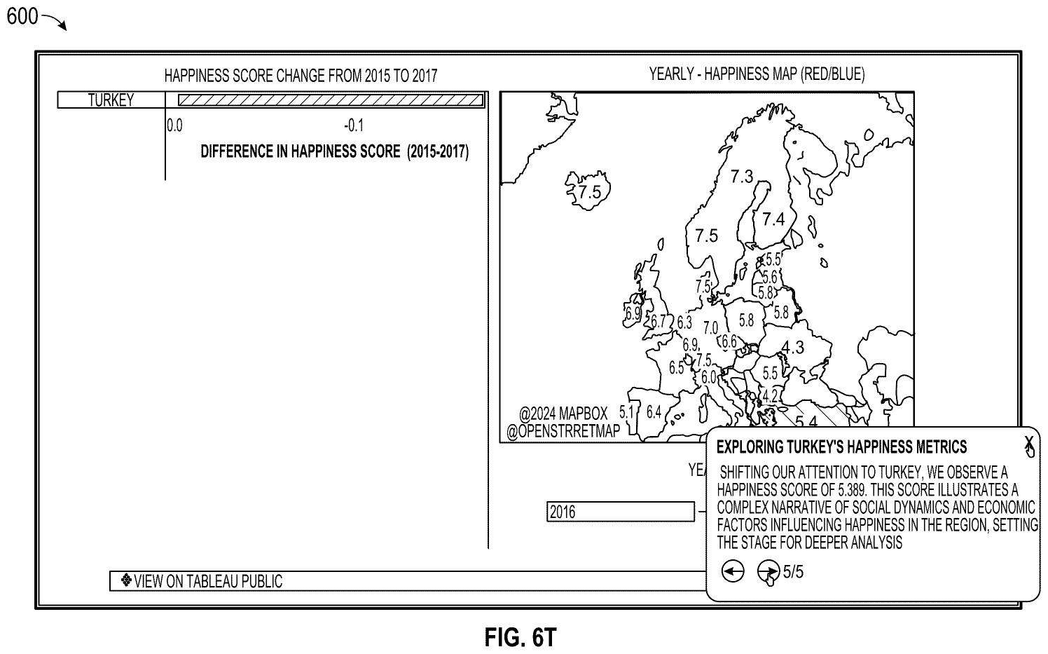

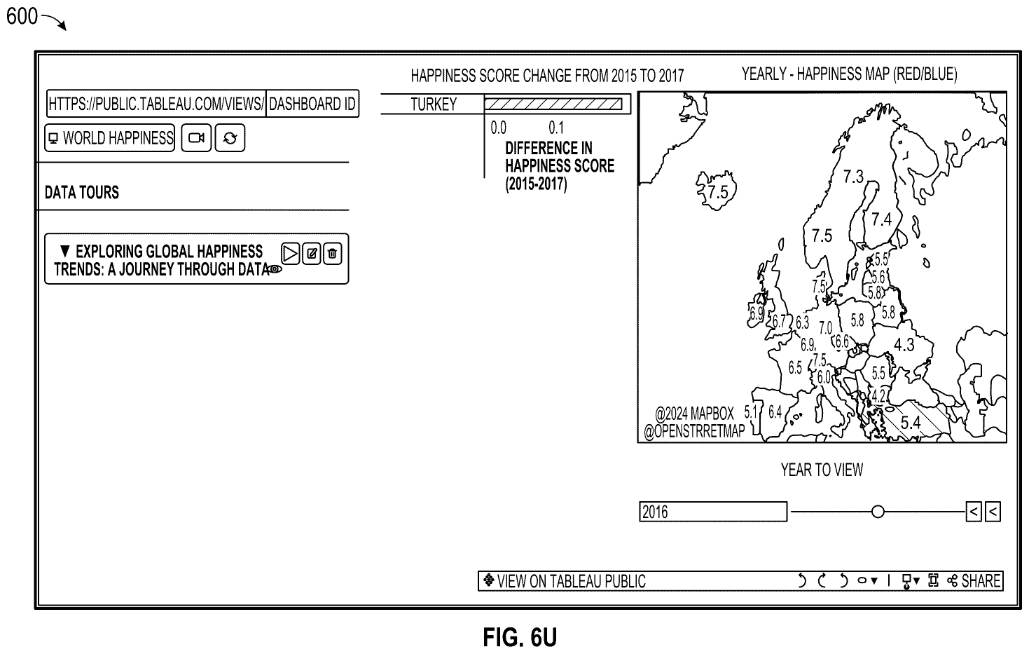

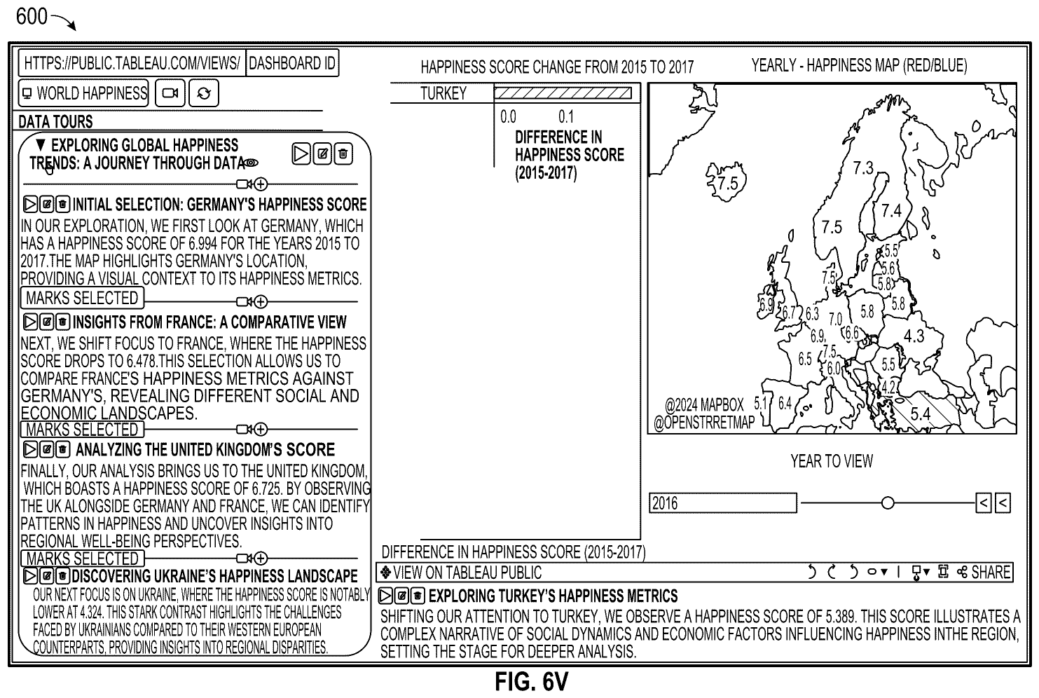

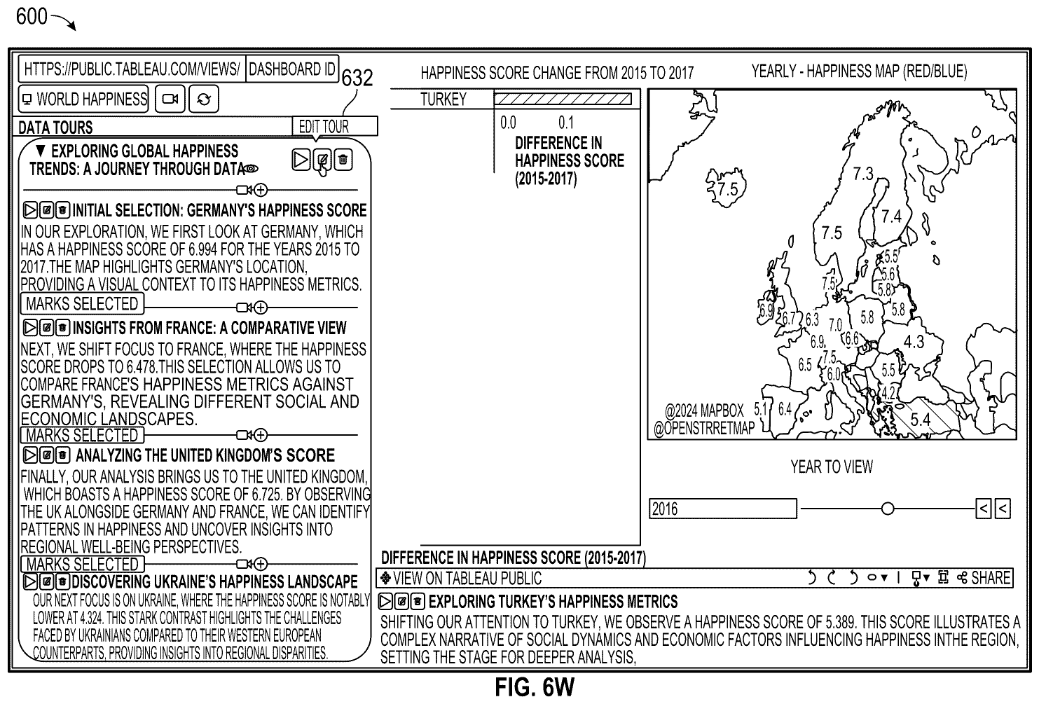

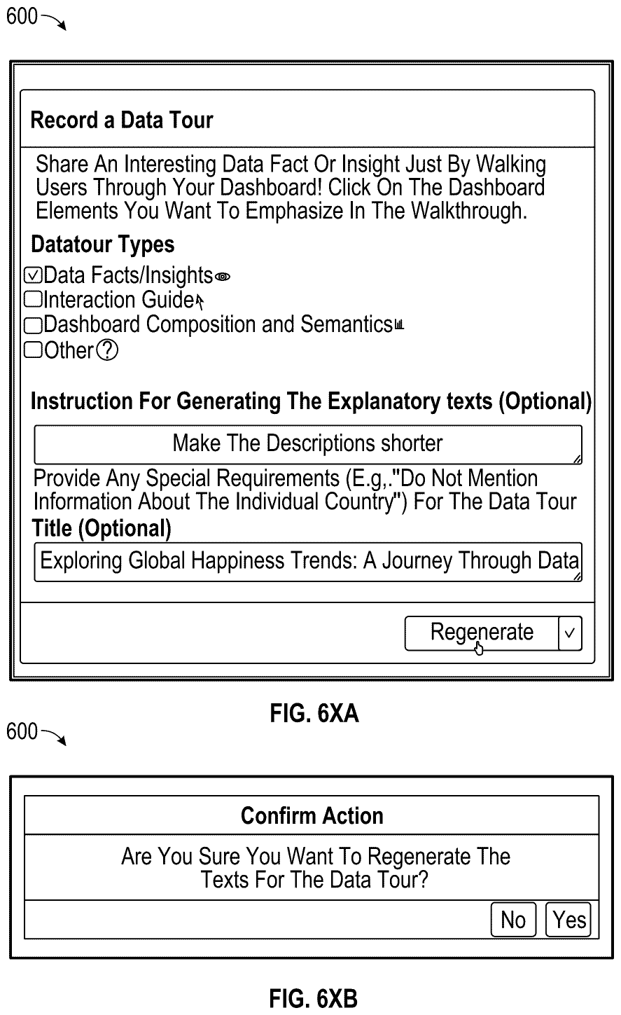

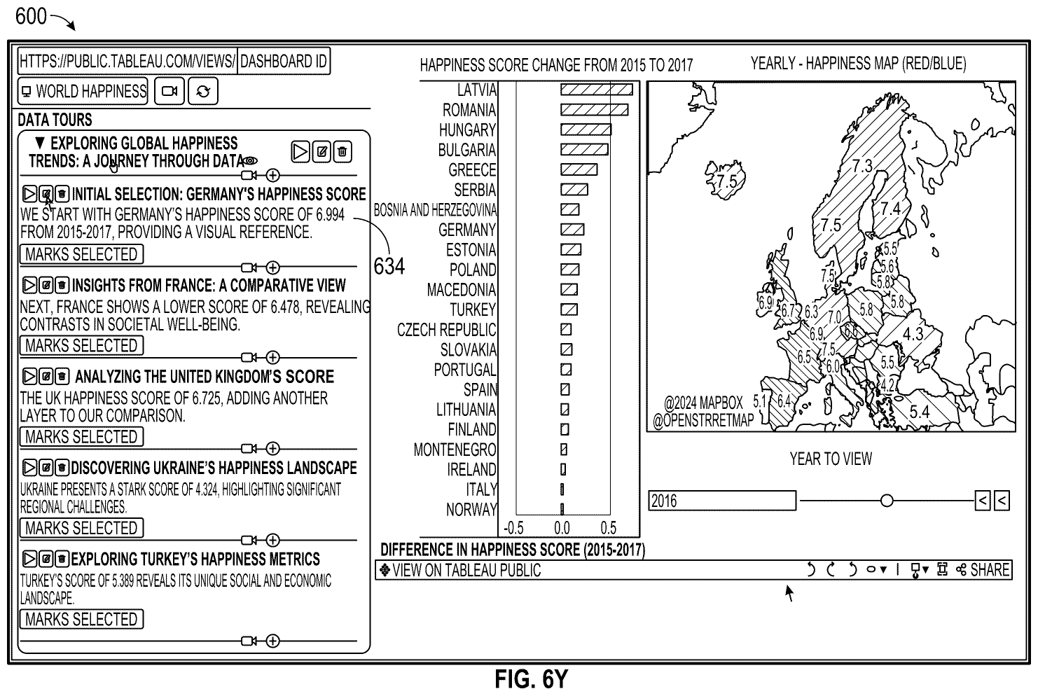

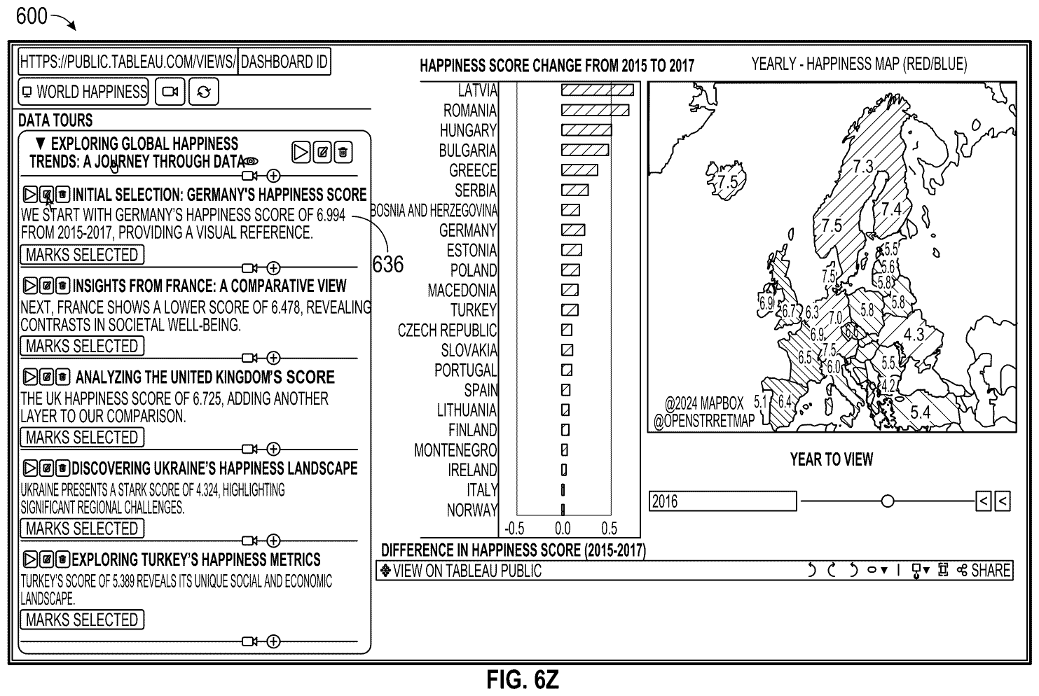

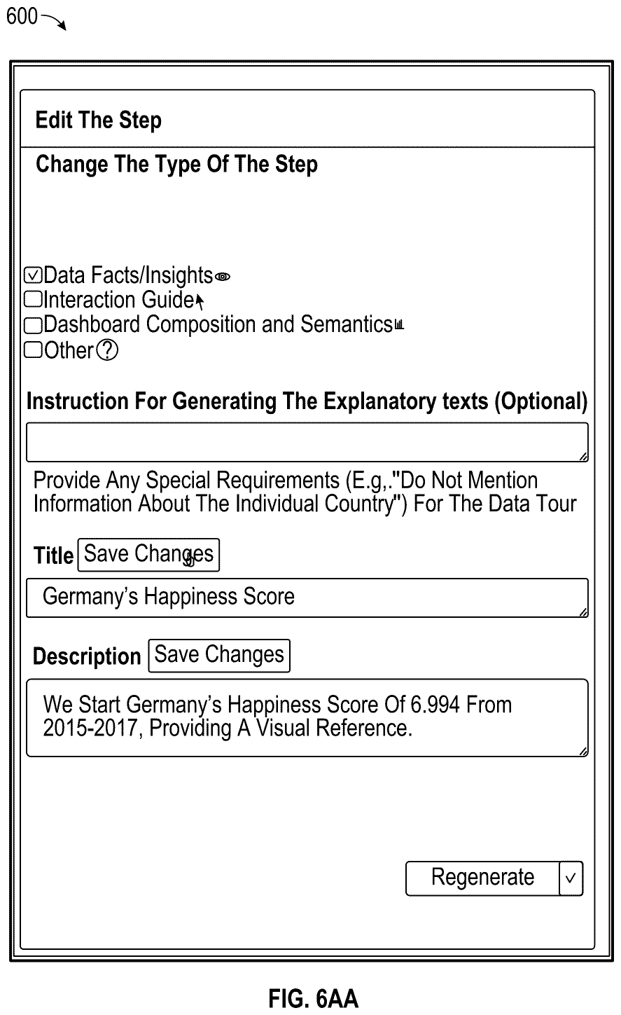

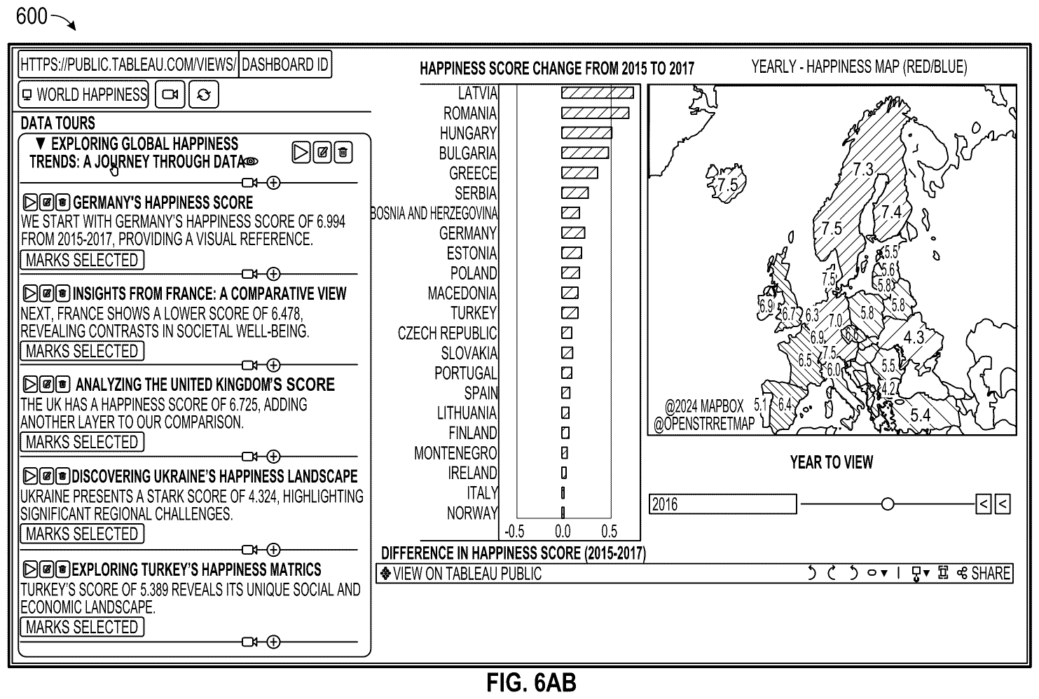

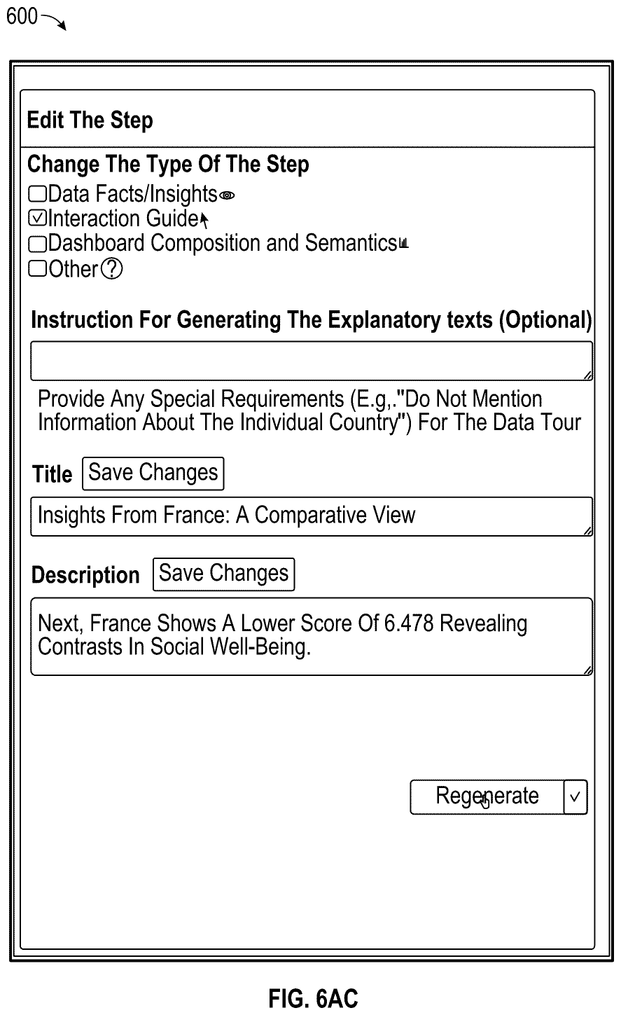

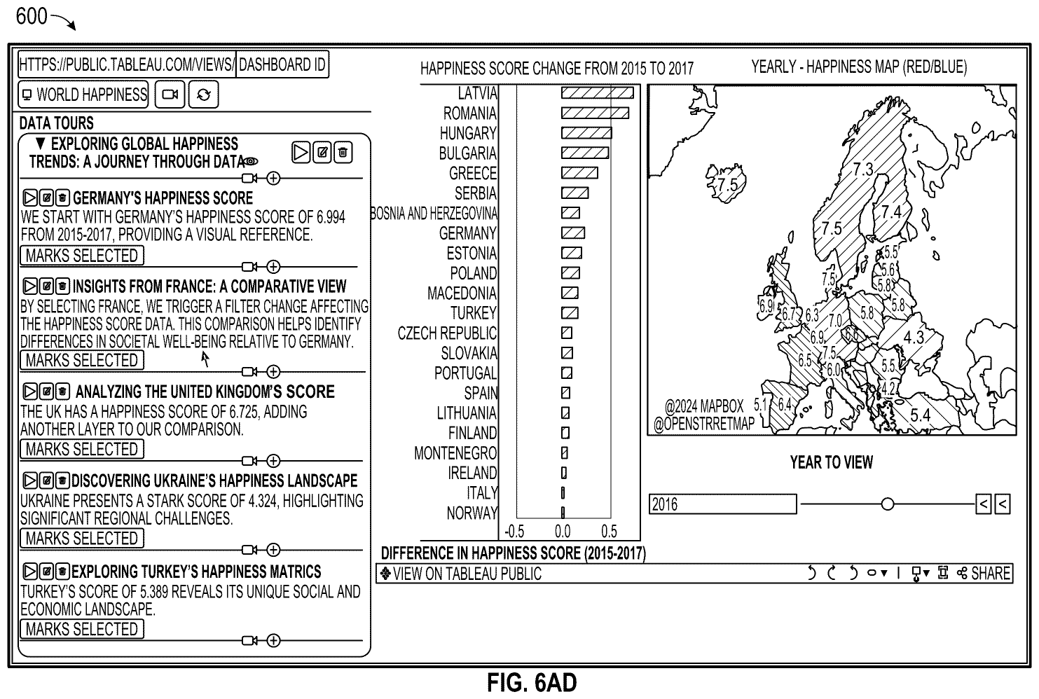

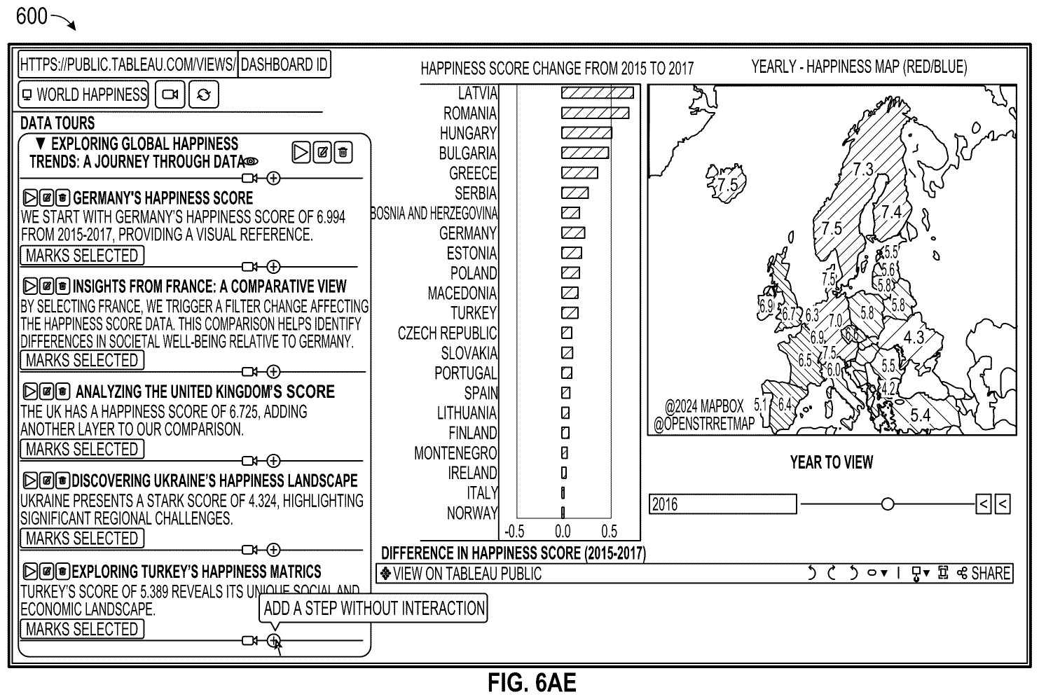

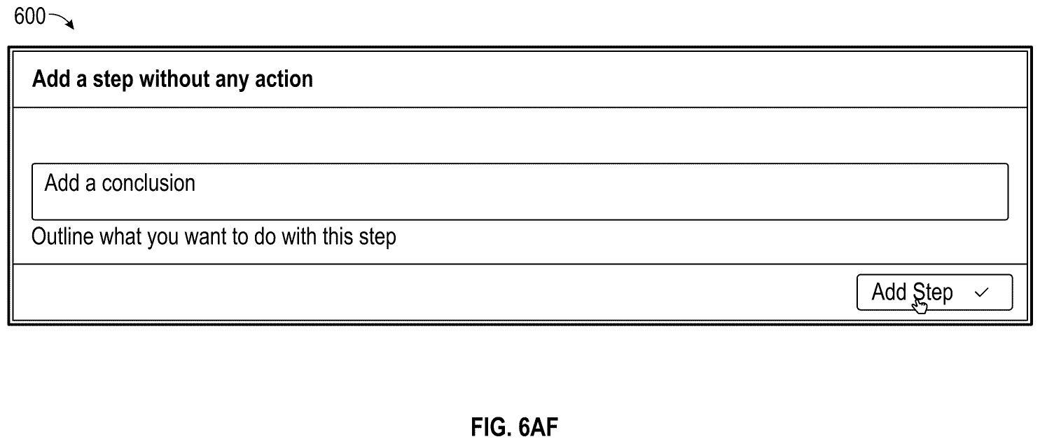

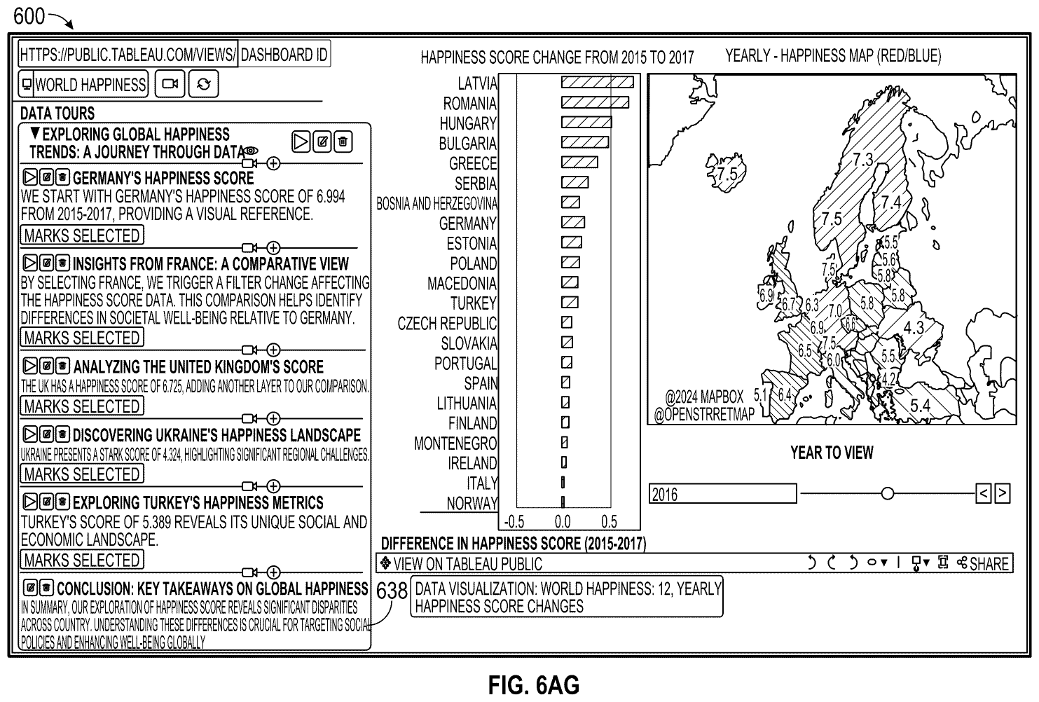

FIGS. 6A-6AG illustrate an example data tour creation and refinement process, according to some implementations. FIGS. 6A-6AG each show an example view of a graphical user interface 600, according to some implementations. FIG. 6A shows an option 602 to specify a link to a dashboard in order to create a data tour. FIG. 6B shows an option 604 for choosing a dashboard from one of several already loaded dashboards. Suppose the user chooses a dashboard showing happiness score across different European countries from 2015 to 2017. The system responds with data visualizations. For example, on the right side is a view 608 of a map of many European countries with their happiness scores shown. On the left side is a chart 606 with a list of the European countries with the happiness score change from 2015 to 2017. Referring next to FIG. 6C, the system provides an option 610 to start the recording process, which brings up the view shown in FIG. 6D. The system provides various options to start a data tour as described above in reference to FIG. 2.

FIG. 6E shows an active recording session as indicated by the affordance 612, and an empty step 614 in the data tour. The system records the user interaction with the dashboard components, the map of the European countries in this example, to populate the step. FIG. 6F shows three empty steps, in list 612, after the user clicks on Germany, France, and the United Kingdom. The recording button 612 continues to show an active recording session. In Suppose, as shown in FIG. 6G, the user clicks on the recording button 612, signifying recording in progress, and stops the data tour recording session. The system causes an LLM model to generate the title for the data tour, and/or the titles and descriptions 618 for the steps of the data tour as shown in FIG. 6H. FIG. 6I shows an option 620 which a user can click to replay a step. The system highlights the selection, map of Germany, and gives the title and the description of the step near the selection. FIGS. 6J and 6K show the steps for the next two selections, France and the United Kingdom.

Some implementations provide an option 622 to record new steps after a data tour has been created, an example of which is shown in FIG. 6L. FIG. 6M shows a view after adding two new steps to the data tour in the added recording session. FIG. 6N shows a view after titles and descriptions 626 for the new selections are again added by the LLM. The system provides an option 624 to play back the data tour with five steps included in it. Selecting the option opens up a new view of the interface for the data tour, as shown in FIG. 6O, which shows the title 630 of the data tour and an affordance 628 to start the data tour. The system then plays the data tour allowing the user to step through all the steps (e.g., five steps) one after the other as shown in FIGS. 6P-6T. After viewing a last step, the system allows the user to close the data tour and return to an authoring view: FIG. 6U shows the data tour encapsulated in a collapsible accordion. The tour has a title and options to edit the tour. Some implementations, as shown in FIG. 6V, present the steps of the data tour as a list where each step is represented in a separate row.

After the data tour has been created, the system allows the user to continue to edit and refine the data tour, an example of which is shown by the option 632 in FIG. 6W. FIGS. 6XA-6XB shows the system allowing the user to provide optional instructions to the LLM, to make descriptions shorter for the steps, and confirms the action to regenerate the texts for the data tour. FIG. 6Y shows shorter descriptions 634 generated for each of the steps. The user can refine individual steps, an example of which is shown in FIG. 6Z where the user is choosing to edit a step 1 by clicking on the corresponding edit affordance 636. The user manually edits the title of step of the data tour as shown in FIG. 6AA. FIG. 6AB shows the updated title for the step. The user can also change the data tour type for a step during the process of refining a data tour. FIG. 6AC shows the user changing the data tour type for step 2, France, to an Interaction Guide. FIG. 6AD shows that the data tour type for step 2, France, is changed from focus on the data to a focus on an interaction with the chart allowing the data tour to target a different audience from one for which it was originally created. Some implementations allow the user to add a step to the data tour without an interaction with the dashboard component by providing instructions to the LLM. FIGS. 6AE-6AF show the user adding a conclusion step to the data tour using the LLM. FIG. 6AG show the data tour interface with a conclusion 638 added at the bottom of the list of steps.

### Example Process Flows for Authoring Dashboard Guidance Using the System

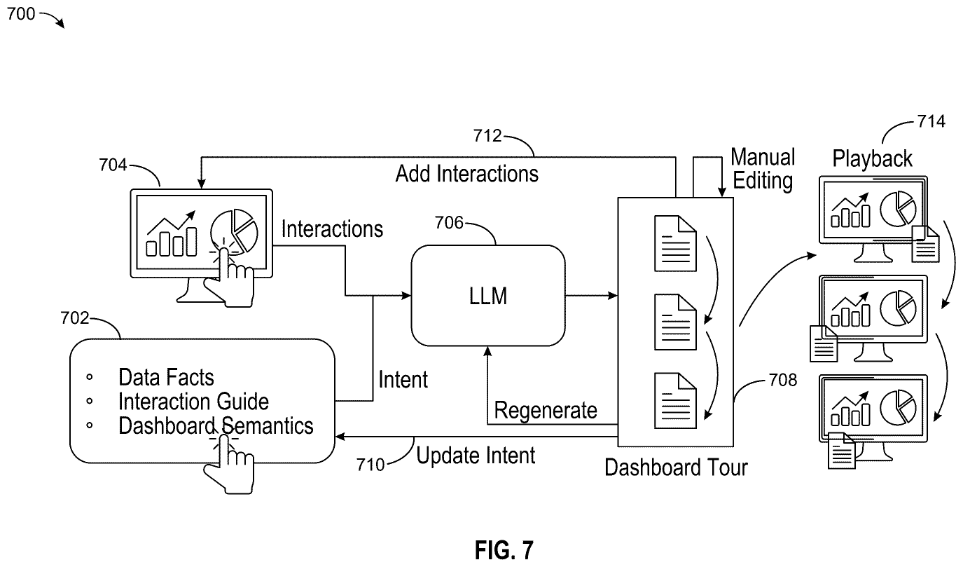

FIG. 7 is an example process flow 700 for authoring dashboard guidance using the system 100, according to some implementations. In some implementations, the system 100 supports authoring guidance for different types of dashboards. In some implementations, the example process flow 700 is web-based (e.g., using APIs). As shown in FIG. 7, at a dashboard, an author provides two inputs to the system 100 for authoring guidance: (1) a communication intent 702 (e.g., data facts, interaction guide, dashboard semantics, etc.) for the guidance, e.g., a diverse communication intent, and (2) sequence of interactions 704 on the dashboard (e.g., selecting data points, brushing data points) to specify components of interest for the guidance. Each interaction of the sequence of interactions 704 is mapped to a guidance step to feature relevant explanatory text generated by an LLM 706 (e.g., LLM in FIG. 1) and form a step-by-step guide, e.g., a dashboard tour 708. This “interaction-first” approach allows the author to rapidly create guidance with minimal effort by vetting generated content and using it to scaffold and refine the guidance narrative, e.g., expediting authoring. The author provides more detailed instructions (e.g., updated intent(s) 710, added interaction(s) 712) to the LLM 706 to fine-tune styling and tone, e.g., expediting authoring and supporting diverse communication intents. While editing, the author plays the guide through a sequential play back of interactions 714. The sequential play back of interactions 714 is shown as a text overlay over the dashboard and placed in an area where a corresponding interaction takes place. The sequential playback of interactions 714, together with text overlays, provides takeaways, insights, or interaction paradigms in an engaging manner, e.g., providing interactive, personable guidance. In some implementations, the example process flow 700 is configured in a user interface (e.g., in reference to FIGS. 4, 9 and 11).

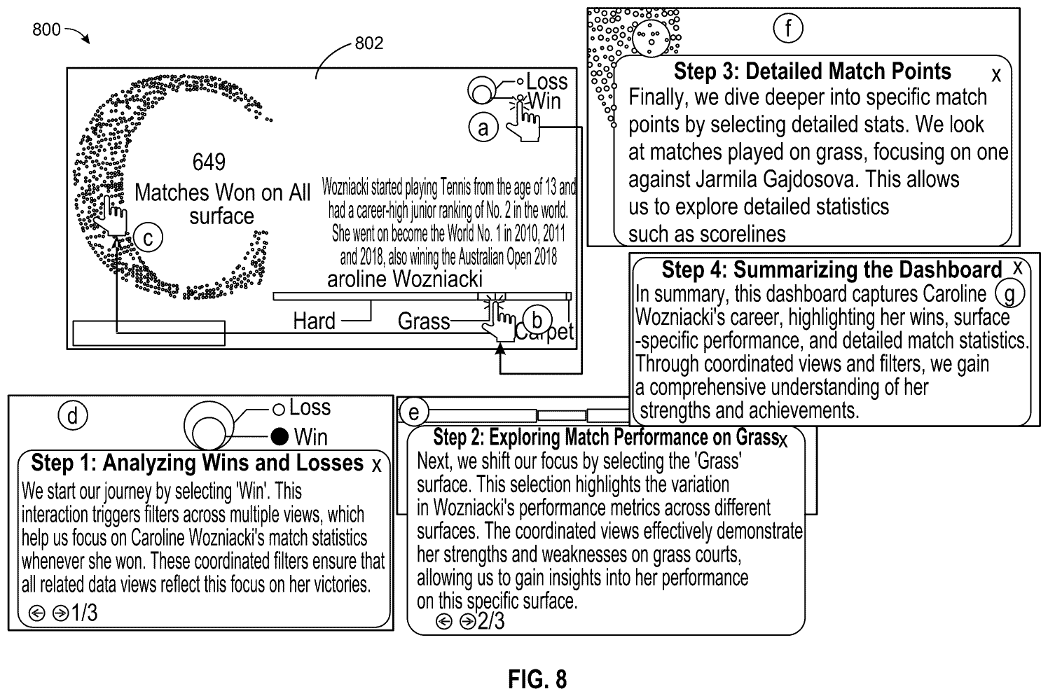

FIG. 8 shows another example process flow 800 for authoring dashboard guidance using the system 100, according to some implementations. In some implementations, the example process flow 800 provides an interactive dashboard tour to guide a dashboard user. In particular, the example process flow 800 is based on a dashboard 802 that displays matches played by a player (e.g., a professional tennis player) in the shape of letter “C.” The dashboard 802 supports several interactions created by following a guide. In some implementations, a user (e.g., a dashboard author) selects “Interaction Guide” as a communication intent (e.g., communication intent 702 in FIG. 7) for the system 100 and performs three consecutive click selections (e.g., steps (a), (b), (c)) on the dashboard 802. The system 100 automatically generates content for the guide by prompting a LLM (e.g., LLM in FIGS. 1 and 8), which uses the communication intent and interactions provided by the user. The guide is delivered as a step-by-step walkthrough or tour (e.g., steps (d), (e), (f)) where each step plays back the original interaction while placing the title and description for the step as an overlay near the location of interaction. The user can refine the content manually, provide further instructions to the LLM, or add or remove steps from the guide. For example, the step (g) in FIG. 8 shows a step added by the user by prompting the LLM to summarize the purpose of the dashboard 802.

In some implementations, the system 100 for authoring dashboard guidance expedites authoring while supporting expressivity. Guidance is quick and easy to author, while retaining ownership of the content. Authors are given quick starting points, create content spanning a broad range of communication intents, and easily iterate over style and tone. In some implementations, the system 100 supports diverse communication intents for content generation. In some circumstances, the communication intents are customized and redirected as needed. In some implementations, the system 100 provides interactive, personable guidance, which is provided in an engaging and understandable manner, especially for intricate dashboards and complex data scenarios. Similarly to human guidance interactions, users are able to control the pace of the guidance being received. In some implementations, the system 100 provides co-located guidance. Guidance is provided in the context of use in the dashboards, as opposed to a separate window or panel. This helps minimize context switch and makes for more intuitive and more engaging guidance.

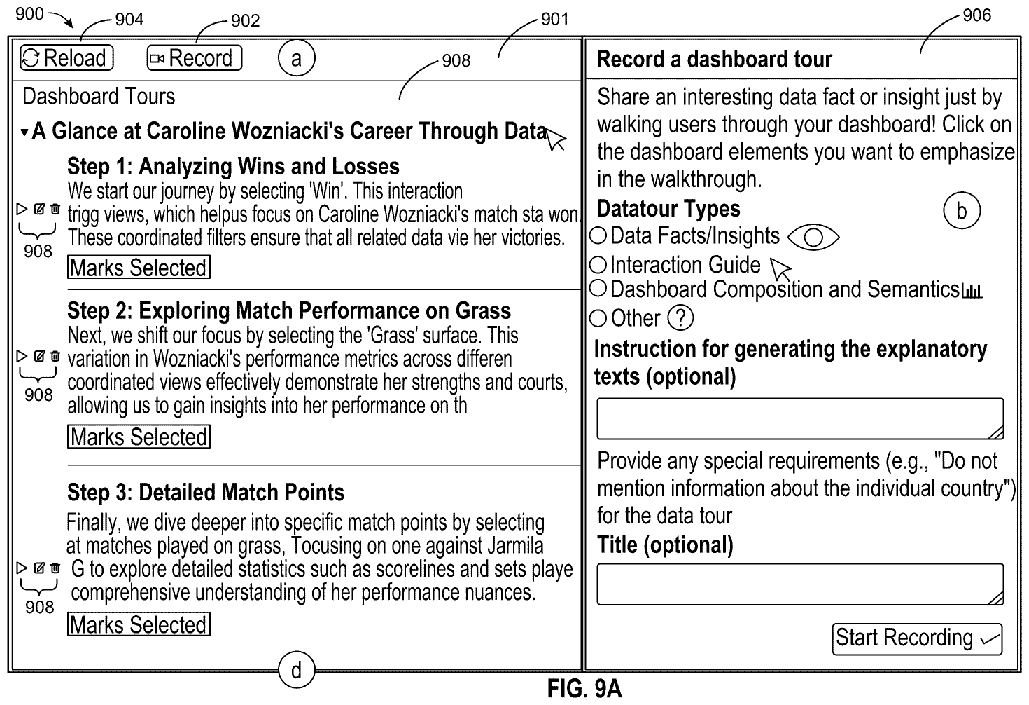

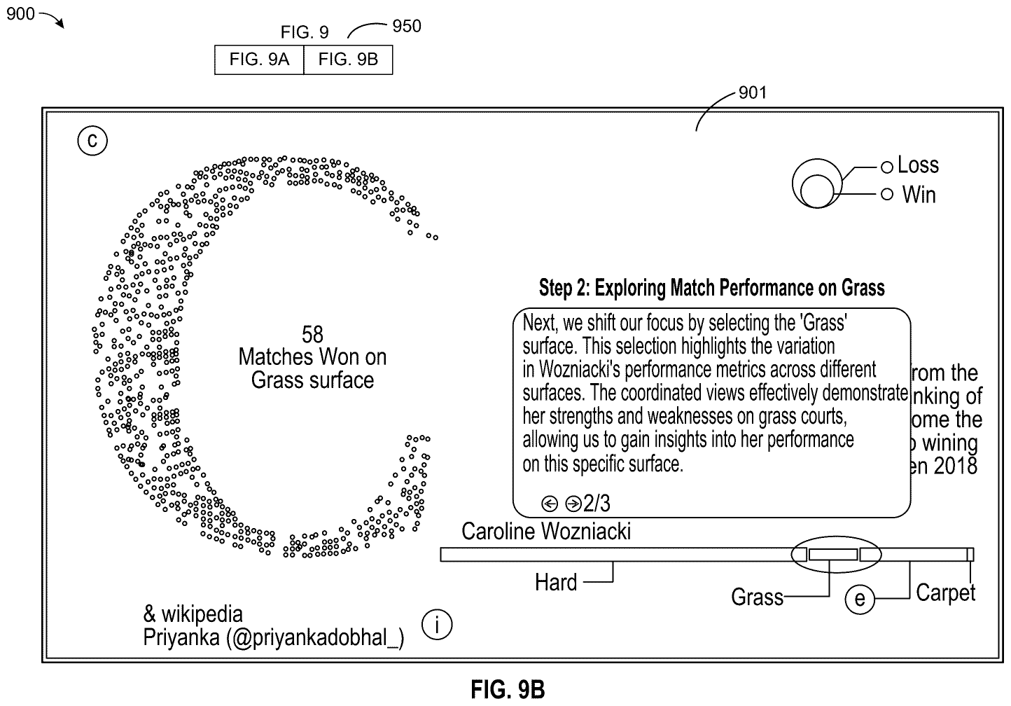

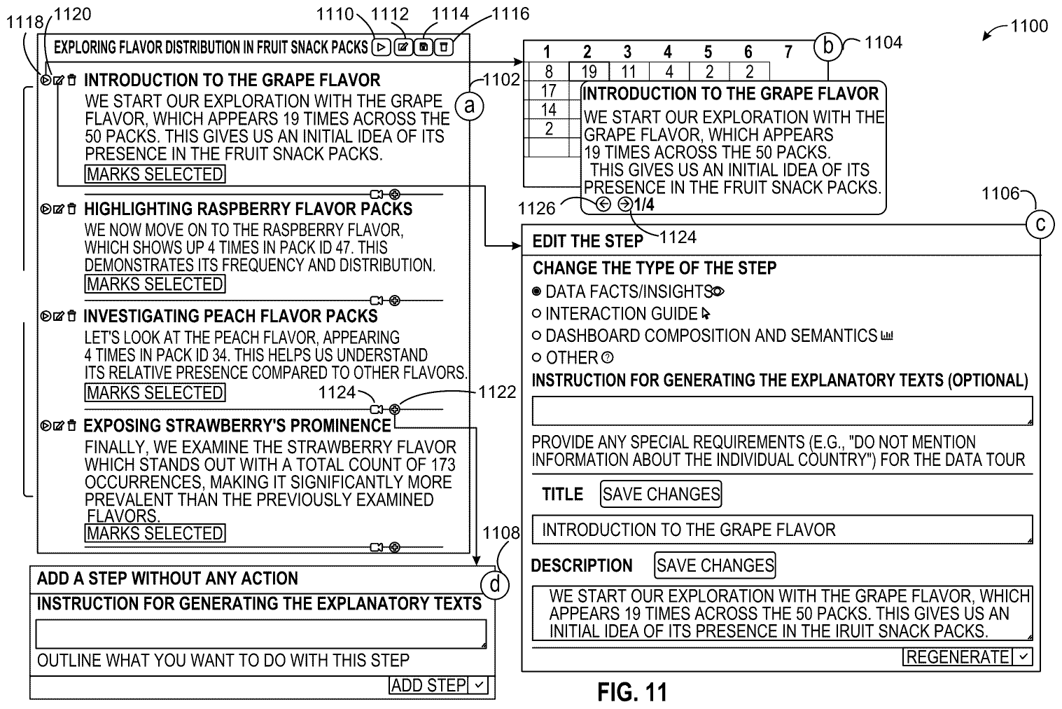

FIGS. 9A and 9B show another example process flow 900 for authoring dashboard guidance using the system 100, according to some implementations. FIG. 9A and FIG. 9B are partial views of FIG. 9 (e.g., FIGS. 9A and 9B form FIG. 9 according to a figure configuration 950 shown in FIG. 9B). In some implementations, the example process flow 900 is based on a user interface (e.g., the editing interface 400 in FIG. 4, the editing interface 1100 in FIG. 11) associated with the system 100 to author guidance for dashboard 901. A step (a) of the example process flow 900 shows buttons (e.g., recording button 902 and reloading button 904) for recording interactions and reloading the dashboard 901. In some implementations, the recording button 902 shows an active recording session (e.g., in reference to the recording button 612 in FIG. 6F). A step (b) of the example process flow 900 shows that in response to clicking the recording button 902, a modal 906 opens where an author selects a communication intent (e.g., communication intent 702 in FIG. 7), provides instructions to the LLM, and a title. A step (c) of the example process flow 900 shows that after selecting the communication intent, the author interacts with the dashboard 901 for creating a tour. A step (d) of the example process flow 900 shows that in response to the author's interactions, a dashboard tour 908 is created using the LLM. Each step in the tour contains three icon buttons 908 for playing back the original interaction, editing the step, and deleting the step. A step (e) of the example process flow 900 shows a play back of a step in the dashboard 901. The title and description appear as an overlay in the dashboard 901. In some implementations, in the step (b) of the example process flow 900, providing instructions to the LLM and/or a title by the author is optional.

FIG. 10 shows example JSON formatted objects 1000 for storing dashboard metadata and interactions associate with a dashboard, according to some implementations. In some implementations, a first JSON formatted object 1002 illustrates a snippet of information extracted for a zone in a dashboard. In particular, the first JSON formatted object includes a chart named “HEATMAP” with three data columns. A second JSON formatted object 1004 illustrates an author-performed interaction saved as a step for a guide. In particular, the second JSON formatted object 1004 includes information about event type, selected marks data, and coordinated view changes.

In some implementations, an author uploads a dashboard in the system 100 by providing its unique identifier in the URL. A dashboard is a collection of zones, where each zone includes elements such as charts, images, UI widgets, or texts. In some implementations, the original dashboard is hosted in a public and/or a private server for providing web services for dashboards. In some implementations, an embedding API is used to extract metadata associated with all zones of a dashboard. For example, for a zone that includes a chart, encoding and marks are extracted. In another example, for a zone that includes text, raw text data is extracted and used as a context for prompting LLMs when authoring guidance. In some implementations, extracted metadata are stored in a JSON object (e.g., the first and second JSON formatted objects 1002 and 1004), and the JSON object is further sent to an LLM (e.g., LLM in FIGS. 1 and 7).

In some implementations, an author provides communication intents (e.g., communication intent 702 in FIG. 7) and instructions (e.g., sequence of interactions 804 in FIG. 8) to the LLM for generating a guide (e.g., a step-by-step guide, a dashboard tour). In some implementations, an author provides several metadata about the dashboard tour to outline an overall goal of the guide. For example, as shown in FIG. 9, the step (b) of the example process flow 900 illustrates a virtual interface (e.g., the editing interface 400 or a part of the editing interface 400 in FIG. 4) for providing metadata. In some implementations, metadata includes a communication intent, an instruction, and/or a title. Specifically, in some implementations, the communication intent includes semantics, interaction guide, and data facts, e.g., diverse communication intents. In response to receiving a communication intent, the system 100 generates a guide corresponding the communication intent. For example, for a guide with data facts as the communication intent, a prompt of “focus on explaining data facts and insights for this dashboard tour” is provided to the LLM for generating a guide. In some implementations, an author specifies instructions or requirements for a dashboard tour. In particular, the functionality for inputting instructions or requirements is the same as how an author would provide instructions to an LLM. In some implementations, an author provides a title for a dashboard tour. When a tile is provided, the LLM is not prompted to generate additional title(s). In some implementations, providing an instruction and/or a title as part of metadata is optional.

In some implementations, the system 100 tracks several dashboard interactions for identifying steps of a step-by-step guide, e.g., expediting authoring while supporting expressivity and providing interactive, personable guidance. In some implementations, the system 100 tracks chart interactions including selection, brushing, and filters that are applied to other dashboard views as a result of these interactions. In some implementations, the system 100 tracks interactions with UI widgets including buttons, dropdowns, checkboxes, and radio buttons. In some implementations, the system 100 records changes to multiple coordinated views resulting from interactions with UI widgets. In some implementations, the system 100 stores interactions in a JSON object (e.g., in FIG. 10). For example, the second JSON formatted object 1004 of FIG. 10 shows an entry for a select interaction.

In some implementations, two prompts are provided to an LLM (e.g., LLM in FIGS. 1 and 7) to generate a guide. A first prompt provides a JSON formatted object (e.g., the first JSON formatted object 1002, the second JSON formatted object 1004) that summarizes a dashboard and includes a short definition for each communication intent. A second prompt is used to generate the guide. The second prompt requires author-provided metadata about the tour and a set of interactions. The following is a sample prompt that can be used to generate the text:
“The following is the JSON object for a data tour, outlining the steps from the data tour—<JSON Object>. The individual events are recorded in the ‘steps’ key. The ‘coordinatedView Change’ key in each step represents changes to the coordinated views of the dashboard as a result of the event.
Generate a title and short description for each event/step in natural language. Craft a story out of the steps and write the title and description accordingly.
Return in the following JSON format {‘title’: <tour title>, ‘steps’: <collection of event object with two keys, ‘title’ and ‘description’>}. Finally, the user has provided the following custom instruction—<Instruction>. Consider it while creating the content for the tour.”

FIG. 11 shows another example editing interface 1100 for authoring dashboard guidance using the system 100, according to some implementations. In some implementations, a dashboard tour generated by the system 100 is encapsulated in a card displayed via the example editing interface 1100, which is used by an author to validate and refine the dashboard tour. In some implementations, the example editing interfaces 400 and 1100 include similar functionalities for authoring dashboard guidance. In some implementations, the example editing interface 1100 includes a main interface 1102 (e.g., labeled with “a”) that encapsulates all steps and editing features in the dashboard tour. An example tour 1101 displayed via the main interface 1102 includes a title and several steps. Each step contains a title and description and is presented in a separate row. A top row of the main interface 1102 shows a title and editing features. The editing features of the main interface 1102 include a play button 1110 that hides all other components except dashboard(s) and plays all steps one by one. The editing features of the main interface 1102 also include an edit button 1112 that opens a setting modal (e.g., modal 906 in FIG. 9). In the setting modal, the author can revise global settings of a tour. For example, the author can change a communication intent (e.g., communication intent 702 in FIG. 7) from data facts to an interaction guide so as to change the overall content of all steps within a tour. In another example, the author can provide custom instructions (e.g., make the descriptions shorter) to the LLM and/or manually edit the title of a tour.

In some implementations, editing the title of a tour is optional. The editing features of the main interface 1102 also include a saving button 1114 and a deleting button 1116. In particular, the author can save the tour in a database by clicking the saving button 1114. The author can delete (e.g., permanently) the tour from the system 100 by clicking the deleting button 1116. Additionally, each step of the tour (e.g., shown in the main interface 1102) includes icon buttons. The icon buttons includes a first button 1118 that plays back interaction(s) in an interface 1104 (e.g., labeled with “b”) associated with an individual step. The icon buttons also includes a second button 1120 that opens a modal (e.g., an interface 1106 labeled with “c”) for editing the setting for an individual step. In particular, the modal enables the author to change a communication intent for a step, provide (e.g., add) further instruction for regenerating the step, and manually editing title and description. The icon buttons also includes a third button 1122 to open an interface 1106 (e.g., labeled with “b”) for the author to insert a new step without any interaction and outlining instructions (e.g., “add a transition step here”). In particular, the third button 1122 helps the author to insert steps that provide context, summary, or transitions to the narrative. The icon buttons also includes a fourth button 1122 (e.g., a “Record” button) to record new interactions and add them as news steps to the guide.

In some implementations, the author playbacks the tour. In some circumstances, the author uses a play button (e.g., the first button 1118) with a step to play the particular step in an authoring view (e.g., the interface 1104). In particular, the author uses a forward icon 1124 and a backward icon 1126 on an overlay to move back and forth in the tour. In other circumstances, the author uses the play button 1110 at the top of the main interface 1102. In some implementations, in response to clicking the play button 1110, other authoring controls on the main interface 1102 are hidden for fully showcasing the dashboard and starting the guide from the beginning. In some implementations, the system 100 allows the author to provide data updates, reuse past data tours to create new ones, and/or personalize tours.

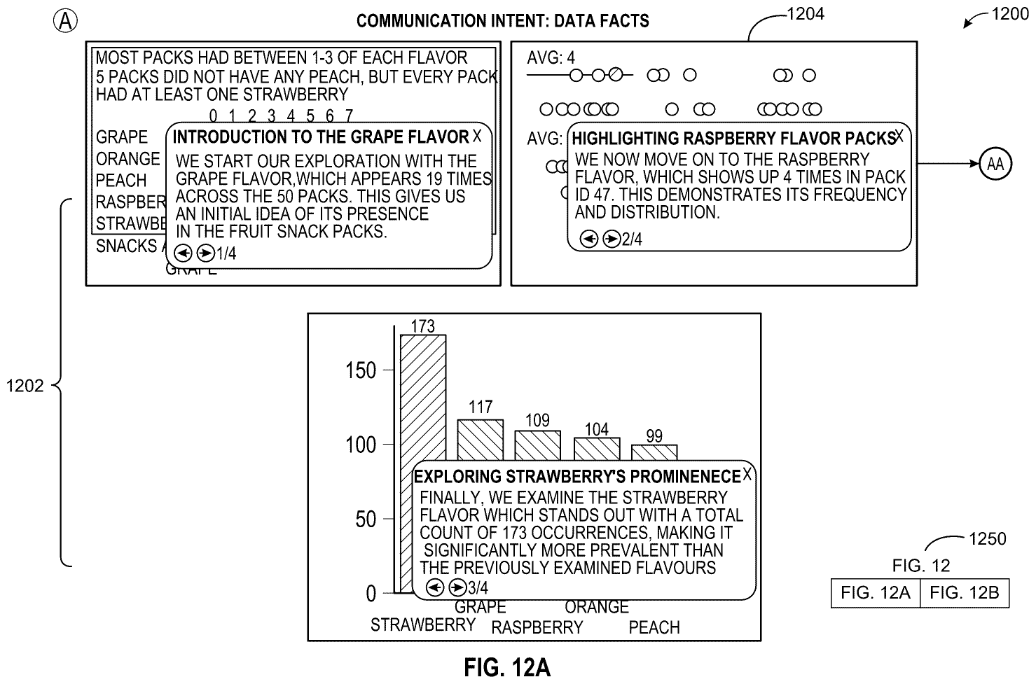

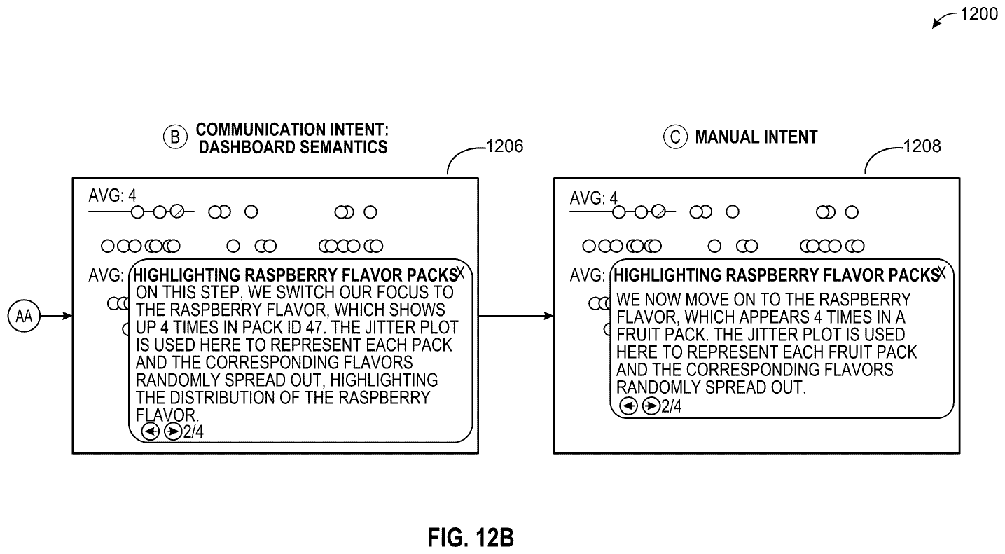

FIGS. 12A and 12B show an example dashboard tour 1200 generated by the system 100, according to some implementations. FIG. 12A and FIG. 12B are partial views of FIG. 12 (e.g., FIGS. 12A and 12B form FIG. 12 according to a figure configuration 1250 shown in FIG. 12A). In some implementations, the example dashboard tour 1200 analyzes flavors (e.g., strawberry, orange, peach, etc.) in fruit snacks. The example dashboard tour 1200 illustrates steps 1202 (e.g., labeled with “a”) associated with the example dashboard tour 1200. In some implementations, the steps 1202 associated with the example dashboard tour 1200 receives a communication intent (e.g., data facts included in the communication intent 702 in FIG. 7) from an author. As shown in FIG. 12, a second step 1204 of the steps 1202 focuses on Jitter Plot. The author can change the communication intent and/or make manual edits to update a step. For example, in the second step 1204, the author changes the communication intent to dashboard semantics to form an updated second step 1206 that includes an explanation of Jitter Plots for users. In another example, based on the updated second step 1206, the author manually edits the description to form another updated second step 1208 for a clearer explanation.

### Formative Study

Some implementations presented herein are directed to a formative study for developing dashboard guidance and creating the system 100 with dashboard guidance to author interactive and step-by-step walkthrough overlays (e.g., dashboard tours).

A formative study is conducted with dashboard practitioners to understand guidance authoring practices and practical challenges with respect to dashboard guidance. In some implementations, dashboard practitioners favor dynamic guidance that walks users through complex data, interaction, and insights instead of static guidance (e.g., technical documents). In some implementations, a single guidance may not fit all users as their audiences showcase diverse analytical needs and skills. In some implementations, creating multiple versions of the same guidance for different audiences requires time, multiple tools, and significant rework every time a dashboard is updated.

In some implementations, a user (e.g., an author) creates a dashboard tour by expressing their communication intent, e.g., interacting with the dashboard components of interest and providing minimal context on their communication intent. The system 100 captures the interaction, compiles a sequence of key demonstration segments, and links interacted dashboard components with the respective segments. A LLM is used to generate explanatory title and description for each key segment. The system 100 plays back the tour as a step-by-step guide where each step shows the original interactions for the step, along with the explanatory title and description placed near the location of the interactions as overlays (e.g., in reference to FIG. 7). In some implementations, the system 100 acts as an authoring platform and provides several features for revising the initial guide, including capturing new interaction steps, and providing custom instructions for the LLM.

In some implementations, the formative study is conducted with a plurality of participants, e.g., nine data professionals (P1-P9). Each participant was conducted with an interview session including three parts: (1) in the first part, each participant shared their background, professional duties, and target users, (2) in the second part, each participant was asked about experience with creating guidance, understanding the common formats, contents, and challenges of dashboard guidance, and (3) in the third part, participants brainstormed with to outline requirements and design choices for a potential guidance authoring system. A thematic analysis of the interview transcripts, recorded audio, and study notes was performed. Responses to interview questions were aggregated across the participants and recurrent themes were identified under each question.

In some implementations, the participants shared their experiences creating and deploying dashboards for a broad range of audiences and domains. For example, some participants supported dashboarding needs of small-to-medium specialized teams in their respective organizations, e.g., P3 and P7-9. In another example, some participants supported much larger and diverse audiences with wildly varying levels of visual literacy skills, e.g., P1, P4, and P5. In yet another example, some participants worked with a broad range of clients in a consulting capacity, e.g., P2 and P6. In some implementations, the participants' feedback were summarized under 4 topics: (a) acknowledging the importance of guidance; (b) strategies for packaging and delivering guidance; (c) characterizing guidance content; and (d) participant needs for a guidance authoring system.

In some implementations, the participants stated that guidance is an integral part of their dashboard authoring practices. For example, in some circumstances, the primary reason for providing guidance is to attend to the diverse skills and needs of the target user bases or clients, e.g., P1-4, P6, and P8-9. In another examples, the participants mentioned that while their dashboards typically have specific analytical purposes, the target user bases may not possess the skills or necessary context to realize those analytical purposes. In particular, the participant frames the act of providing guidance as a translation exercise, e.g., people may not have the same understanding of language or words. This indicates that good guidance goes beyond a mechanical description of what dashboard components are and what they do, but is rather a nuanced authoring exercise: one that requires being attuned to a user's context, picking the right words, and delivering them in an accessible way. This further indicates that, instead of pursuing a fully automated guidance generation solutions, there is a need to support authors to realize their authoring potential.

In some implementations, there is a need to expedite guidance authoring workflows. For example, some participants reported many obstacles to providing guidance, which all point to it being too time-consuming, e.g., time for understanding their users, time for creating guidance, and time for navigating a myriad of authoring tools. Moreover, there are several obstacles that may have a detrimental impact on the time, including: the large scale of dashboards and guidance documentation they need to support; the diversity of users and visual literacy skills which demands more carefully crafted guidance; and constant data updates, which require guidance content to be maintained and changed accordingly. While authoring agency is important, it may be desired to have some level of automated authoring assistance to kick start the process, e.g., clicking a few buttons.

In some implementations, there is a need to provide interactive, personable, and embedded guidance, e.g., text annotations and on-off overlays, as in-situ dashboard guidance. In some implementations, dashboard guidance includes on demo videos (e.g., in-person walkthroughs, and phone calls). Step-by-step demonstrations are effective at demonstrating usage scenarios and meeting users where they are at. In some circumstances, in-person engagements have a sizable impact on their workloads, and are not scalable to large audiences. In other circumstances, self-serve guidance can provide users a similar hand-holding experience.

In some implementations, a dashboard guidance (e.g., dashboard guidance) includes four types of contents for identifying guidance communication intents: (1) a first kind is dashboard semantics and encoding, which explains the different elements of a dashboard, e.g. encodings of a chart or purpose of a dropdown menu; (2) a second kind is interaction guidance, focusing on explaining possible ways to interact with charts and their impacts on other dashboard components; (3) a third kind is data fact, which shows insights and interesting data facts; (4) a fourth kind includes data backgrounds and context explain background information and context about the dashboard.

In some implementations, the dashboard guidance is capable of demonstrating the interactivity and use cases of the dashboards. In some circumstances, the interactive guidance is more engaging for users, and therefore more impactful, e.g., demo videos and walkthroughs that can be quickly and easily authored. In some implementations, the dashboard guidance prioritizes their creative freedom. In some implementations, the dashboard guidance is integrated into dashboards instead of appearing as a separate resource, and becomes more discoverable and meaningful. In some implementations, the dashboard guidance creates multiple guidance items for the same dashboard, tailored to capture different intents and targeted towards different user bases.

Example Computing Device for Generating and/or Displaying Data Visualizations

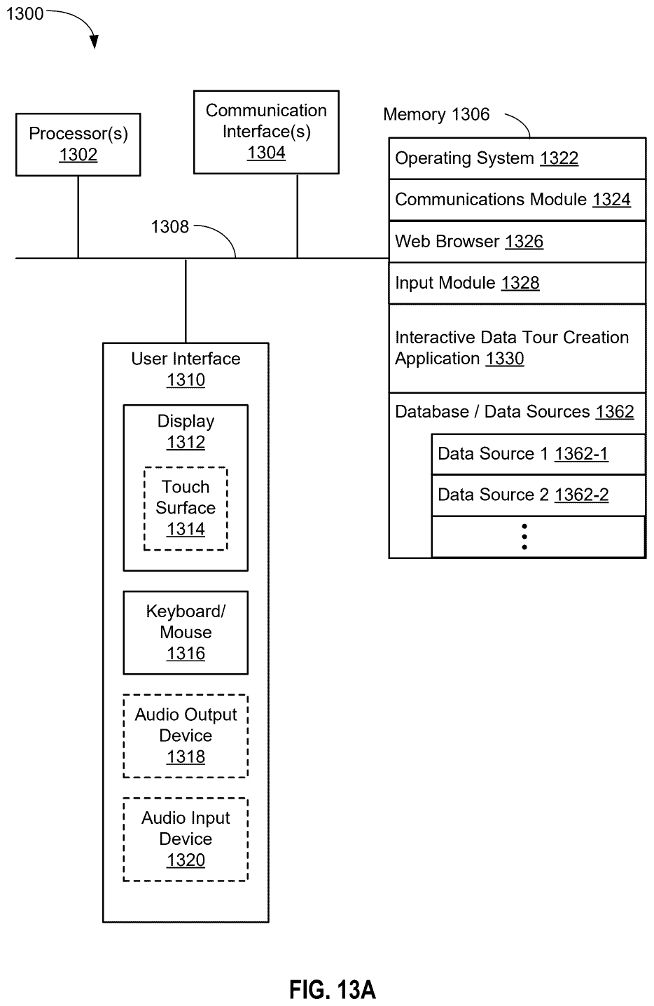

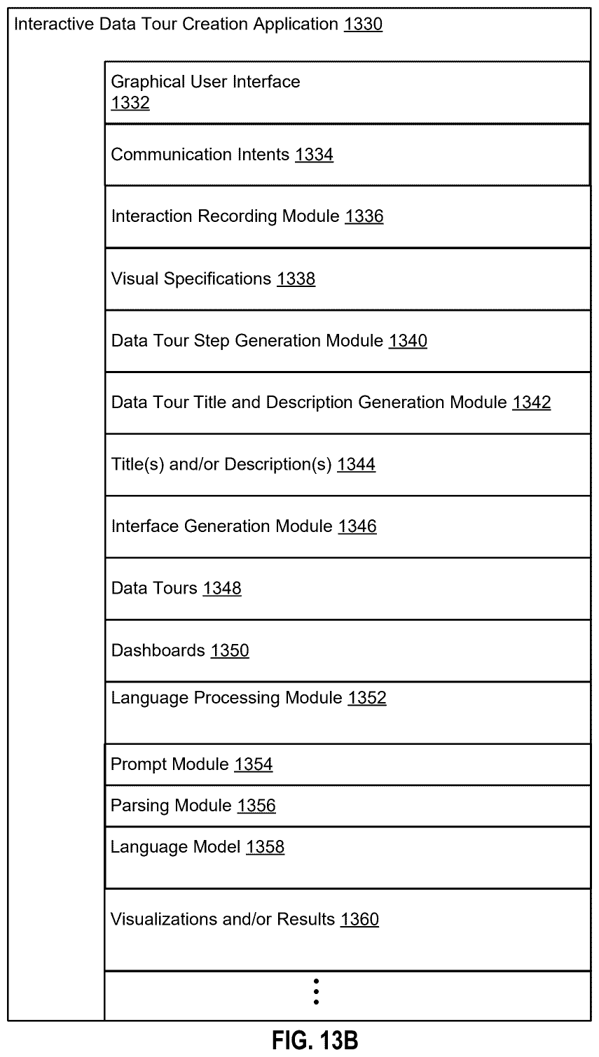

FIGS. 13A and 13B show a block diagram of an example computing device 1300 for interactive data tour creation for dashboards, according to some implementations. In some implementations, the computing device 1300 displays a graphical user interface (e.g., the graphical user interfaces 400, 500, 600). Computing devices 1300 include desktop computers, laptop computers, tablet computers, and other computing devices with a display and a processor capable of running a data visualization application. A computing device 1300 typically includes one or more processing units/cores (CPUs) 1302 for executing modules, programs, and/or instructions stored in the memory 1306 and thereby performing processing operations; one or more network or other communications interfaces 1304; memory 1306; and one or more communication buses 1308 for interconnecting these components. The communication buses 1308 may include circuitry that interconnects and controls communications between system components. A computing device 1300 includes a user interface 1310 comprising a display 1312 and one or more input devices or mechanisms 1310. In some implementations, the input device/mechanism includes a keyboard 1316. In some implementations, the input device/mechanism includes a “soft” keyboard, which is displayed as needed on the display 1312, enabling a user to “press keys” that appear on the display 1308. In some implementations, the display 1312 and input device/mechanism comprise a touch screen display 1314 (also called a touch sensitive display). In some implementations, the display is an integrated part of the computing device 1300. In some implementations, the display is a separate display device. Some implementations include an audio input device 1320 and/or an audio output device 1318. The input devices or mechanisms can be used to provide natural language commands directed to data sources.

In some implementations, the memory 1306 includes high-speed random-access memory, such as DRAM, SRAM, DDR RAM or other random-access solid-state memory devices. In some implementations, the memory 1306 includes non-volatile memory, such as one or more magnetic disk storage devices, optical disk storage devices, flash memory devices, or other non-volatile solid-state storage devices. In some implementations, the memory 1306 includes one or more storage devices remotely located from the processors 1302. The memory 1306, or alternatively the non-volatile memory devices within the memory 1306, comprises a non-transitory computer-readable storage medium. In some implementations, the memory 1306, or the computer-readable storage medium of the memory 1306, stores the following programs, modules, and data structures, or a subset thereof:
an operating system 1322, which includes procedures for handling various basic system services and for performing hardware dependent tasks;
a communication module 1324, which is used for connecting the computing device 1300 to other computers and devices via the one or more communication network interfaces 1304 (wired or wireless) and one or more communication networks, such as the Internet, other wide area networks, local area networks, metropolitan area networks, and so on;
an optional web browser 1326 (or other client application), which enables a user to communicate over a network with remote computers or devices;
an input module 1328, which may include an optional audio input module, to process input and/or signals received from the display 1312, the keyboard/mouse 1316, and/or the audio input device 1320, and/or output signals to the output devices (e.g., the audio output device 1318);
an interactive data tour creation application 1330, which provides a graphical user interface 1332 for a user to construct visual graphics (e.g., an individual data visualization, a dashboard with a plurality of related data visualizations, data tours, and/or textual content). In some implementations, the application 1330 executes as a standalone application (e.g., a desktop application). In some implementations, the application 1330 executes within the web browser 1326 (e.g., as a web application);
referring next to FIG. 13B, a graphical user interface 1332, which enables a user to build data visualization(s), dashboard(s), data tour(s), and/or textual content, by specifying elements visually, audio-visually, and/or via any of the input mechanism described herein. In some implementations, the user interface 1332 includes a plurality of regions or sections, which are used to specify characteristics of a desired data visualization. In some implementations, the regions include a columns shelf and a rows shelf (e.g., for building a data visualization), which are used to specify the arrangement of data in the desired data visualization. In general, fields that are placed on the columns shelf are used to define the columns in the data visualization (e.g., the x-coordinates of visual marks). Similarly, the fields placed on the rows shelf define the rows in the data visualization (e.g., they-coordinates of the visual marks). In some implementations, the shelf regions include a filters shelf, which enables a user to limit the data viewed according to a selected data field (e.g., limit the data to rows for which a certain field has a specific value or has values in a specific range). In some implementations, the shelf regions include a marks shelf, which is used to specify various encodings of data marks. In some implementations, the marks shelf includes a color encoding icon (to specify colors of data marks based on a data field), a size encoding icon (to specify the size of data marks based on a data field), a text encoding icon (to specify labels associated with data marks), and/or a view level detail icon (to specify or modify the level of detail for the data visualization). Different sections may be used to create data tours;
communication intents 1334, examples of which are described above in reference to FIG. 2, according to some implementations;
an interaction recording module 1336 for recording interactions on the graphical user interface;
visual specifications 1338, which are used to define characteristics of a desired data visualization. In some implementations, the visual specifications 1338 is built using the user interface 1332. A visual specification includes identified data sources 1362 (i.e., specifies what the data sources are), which provide enough information to find the data sources 1362 (e.g., a data source name or network full path name). A visual specification 1338 also includes visual variables, and the assigned data fields for each of the visual variables. In some implementations, a visual specification has visual variables corresponding to each of the shelf regions. In some implementations, the visual variables include other information as well, such as context information about the computing device 1300, user preference information, or other data visualization features that are not implemented as shelf regions (e.g., analytic features);
a data tour step generation module 1340 for generating steps for data tours;
a data tour title and description generation module 1342 for generating title and/or descriptions 1344;
an interface generation and coordination module 1346 for generating interfaces for creating dashboards, data tours, and/or coordinating between different modules of the interactive data tour creation application 1330;
data tour(s) 1348;
dashboard(s) 1350;
a language processing module 1352;
a prompt module 1354;
a parsing module 1356;
language model(s) 1358;
visualizations and/or results 1360 for string intermediate data visualizations, dashboards, and/or results; and/or
zero or more databases or data sources 1362 (e.g., a first data source 1362-1), which are used by the application 1332. In some implementations, the data sources are stored as spreadsheet files, CSV files, XML files, flat files, JSON files, tables in a relational database, cloud databases, or statistical databases.

The language processing module 1352 parses natural language utterances (sometimes referred to as commands or natural language queries) directed to the data sources 1362. In some implementations, the language processing module 1352 includes semantic search for understanding conceptual meaning of a query by analyzing relations between words, phrases and/or concepts in the natural language query. This may include natural language processing (NLP) techniques to analyze the structure and meaning of the query, including part-of-speech tagging, named entity recognition and/or sentiment analysis, sentiment analysis for identifying key concepts, entities and relationships present in the query and the content, e.g., using knowledge bases, ontologies and/or taxonomies.

The prompt module 1354 generates prompts for large language models. This module may include NLP model trained to understand natural language descriptions or instructions and convert them into structured prompts suitable for LLMs. Some implementations include optimization(s) to select the suitable prompt based on criteria such as performance metrics, user preferences and/or domain specific characteristics (e.g., for data visualization specification generation). The prompt module 1354 generates prompts based on relevant data fields and data values, and/or rules for generating textual content, details of which are described below. In some implementations, the system uses structured prompts to generate content based on communication intent. For data facts/insights, the prompt emphasizes highlighting patterns and notable data points. For interaction guides, the prompt focuses on explaining user actions and their effects. For dashboard composition, the prompt explains chart encodings and interpretations. Each prompt includes the full dashboard context, relevant component metadata, and specific instructions provided by the author. The system may regenerate content for individual steps when the intent or instructions change. In some implementations, the prompt module 1354 also prompts the trained large language model 11356 using the prompts to generate a structured document following a domain-specific schema based on a shorthand notation, details of which are described below, according to some implementations. The prompt module 1354 also stores any data structures (e.g., rules) for performing the operations described herein.

The parsing module 1356 parses (e.g., performs grid-based parsing) to identify spatial arrangement elements. The parsing module 1356 can also include conventional parsing techniques or algorithms, and/or use grammar rules (e.g., context free grammars) for parsing textual content. In some implementations, the visual specification specifies a data source, a plurality of visual variables, and a plurality of data fields from the data source. The language model 1358 includes one or more large language models (LLMs) that are trained to generate structured documents and/or text. In some implementations, the large language models are finetuned using visual specifications and/or textual content generated for dashboards, data visualizations and/or articles.

In addition to the modules and/or data structures described above, the memory 1306 stores additional modules and data structures that may be necessary for performing the operations described in reference to FIGS. 1-12, and FIG. 14, even if not explicitly described herein. Each of the above identified executable modules, applications, or set of procedures may be stored in any of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1306 stores a subset of the modules and data structures identified above. In some implementations, the memory 1306 stores additional modules or data structures not described above. Although FIG. 13 shows a computing device 1300, FIG. 13 is intended more as functional description of the various features that may be present rather than as a structural schematic of the implementations described herein. In practice, and as recognized by those of ordinary skill in the art, items shown separately could be combined and some items could be separated.

The language models 1358 can include Application Programming Interfaces (APIs) to large language models, which can reside in remote computers connected to the computing device 1300. Smaller inference models can be resident on the computing device 1300 (e.g., may be used for inference without remote access). Large Language Models (LLMs) can be used to generate structured data in formats, such as JSON, YAML, and XML. These formats are widely used for structuring data due to their versatility and compatibility across different systems. The trained LLMs may include pre-trained models, such as GPT-4, which may be further finetuned for the purpose of generating visualization specifications and/or shorthand notations described herein. Large Language Models (LLMs) can be trained on a variety of data formats, including JSON and Python code, to generate structured documents. In some implementations, for training such models, a first step includes collecting a large dataset of JSON files or Python code that represent the desired structure of the output documents or textual content (e.g., headlines, insights). This dataset is diverse and representative of the types of documents (e.g., textual content) to generate. The data may be preprocessed. The raw data may need to be preprocessed to prepare it for training. This can involve tasks like cleaning the data, removing irrelevant parts, tokenizing the text, and converting it into a format suitable for the LLM's input. Subsequently, in some implementations, the model is trained using the preprocessed data for a language modeling task. The model is trained to take the input (e.g., a prompt or description) and generate the corresponding structured output (e.g., JSON or Python code, textual content, overlays).

The trained LLMs can include pre-trained models, such as GPT-4, which may be further finetuned for the purpose of generating text for dashboards, articles, and/or data visualizations, described herein. Large Language Models (LLMs) can be trained on a variety of data formats, including JSON and Python code, to generate structured documents. In some implementations, for training such models, a first step includes collecting a large dataset of JSON files or Python code that represent the desired structure of the output documents. This dataset is diverse and representative of the types of documents (e.g., visual specifications, text) to generate. The data may be preprocessed. The raw data may need to be preprocessed to prepare it for training. This can involve tasks like cleaning the data, removing irrelevant parts, tokenizing the text, and converting it into a format suitable for the LLM's input. Subsequently, in some implementations, the model is trained using the preprocessed data for a language modeling task. The model is trained to take the input (e.g., a prompt or description) and generate the corresponding structured output (e.g., JSON or Python code).

The trained language model can be fine-tuned. Depending on the complexity of the task and the size of the dataset, the LLM can be fine-tuned on the specific domain and data format. Fine-tuning involves further training the model on a target dataset to adapt it to the task at hand. For generating data visualization specification, the trained language model can be finetuned for a specific visualization specifications for data visualizations. After the model is trained, the trained model can be used to generate structured documents based on new prompts or inputs. The model can output the corresponding JSON or Python code and/or textual content, for example, which can then be displayed, parsed and/or processed as needed. In some implementations, the training data and/or target data for finetuning is formatted in a way that preserves the structure of the JSON or Python code or textual content, for example, allowing the model to learn the patterns and relationships within the data. Appropriate evaluation metrics, such as BLEU score, perplexity, or task-specific metrics, can be used to measure the model's performance and guide the training.

In some implementations, the system stores interaction data in a structured JSON format that captures both the direct user action and resulting coordinated view changes. Each interaction record includes: the interacted component identifier, the interaction type (e.g., selection, filter change), associated data values, resulting view updates, and/or component metadata.

In some implementations, the language model integration includes specialized prompt templates for each communication intent type. For data facts/insights, prompts emphasize data patterns and notable findings. For interaction guides, prompts focus on explaining functionality and effects. For dashboard composition, prompts explain visual encodings and interpretation strategies. The system maintains separate prompt contexts for tour-level and step-level content generation.

In some implementations, the system supports multiple content regeneration workflows. When authors change tour-level intent, the system regenerates all step content while maintaining interaction sequences. When changing step-level intent, only that step's content is regenerated. Authors can provide generation instructions at both tour and step levels, allowing fine-grained control over content style and focus. The system preserves these instructions and applies them during any subsequent regeneration.

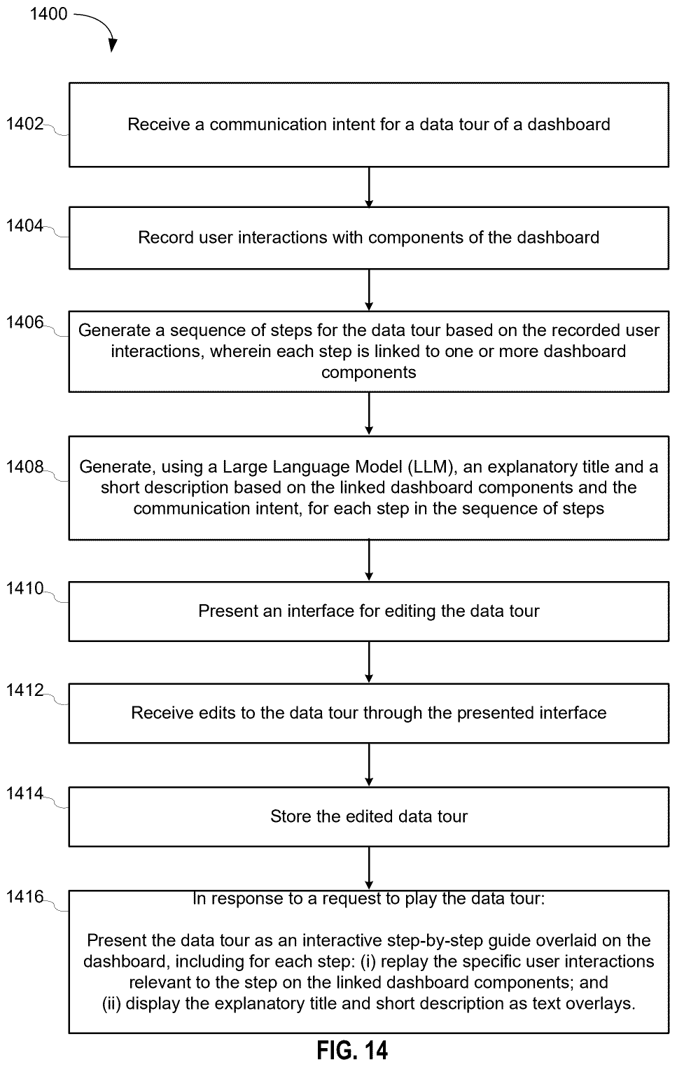

FIG. 14 is a flowchart of an example method 1400 for data tour creation for dashboards according to some implementations. The method is performed at a computing device (e.g., the computing device 1300) having one or more processors (e.g., the processors 1302), and memory (e.g., the memory 1306) storing one or more programs configured for execution by the one or more processors.

The method includes receiving (1402; e.g., by the input module 1328) a communication intent (e.g., the communication intent 1334) for a data tour (e.g., the data tour 1348) of a dashboard (e.g., the dashboard 1350).

The method also includes recording (1404; e.g., by the interaction recording module 1336) user interactions with components of the dashboard. In some implementations, recording user interactions includes capturing at least one of: mouse clicks, keyboard inputs, scroll events, and changes to dashboard settings or filters.

The method also includes generating (1406; e.g., by the data tour step generation module 1340) a sequence of steps for the data tour based on the recorded user interactions. Each step is linked to one or more dashboard components. In some implementations, generating the sequence of steps includes analyzing the recorded user interactions to identify distinct actions or sets of actions, and creating a step for each distinct action or set of actions. In some implementations, actions that derive from the same interaction event are grouped within the same step.

The method also includes generating (1408; e.g., by the data tour title and description generation module 1342), for example, using a Large Language Model (LLM) (e.g., the language model 1358), an explanatory title and a short description (e.g., the titles and/or descriptions 1344) based on the linked dashboard components and the communication intent, for each step in the sequence of steps. In some implementations, generating the explanatory title and short description using the LLM includes providing the LLM with context about the dashboard, the linked components, the recorded user interactions, and the communication intent, and receiving generated text from the LLM based on the provided context.

The method also includes presenting (1410; e.g., by the interface generation module 1346) an interface (e.g., the editing interface described above) for editing the data tour.

The method also includes receiving (1412; e.g., by the input module 1328) edits to the data tour through the presented interface. In some implementations, the interface enables editing of the explanatory title and short description for each step. In some implementations, the interface enables regeneration of content for individual steps using the LLM. In some implementations, regeneration requires selection of a content type from predefined options and optional generation instructions. In some implementations, the interface enables addition, removal, and reordering of steps in the sequence, including providing insertion points in the data tour. In some implementations, the interface enables refinement of the communication intent for the entire data tour or individual steps.

The method also includes storing (1414; e.g., by the interface generation module 1346) the edited data tour.

The method also includes, in response (1416) to a request to play the data tour, presenting (1418) the data tour as an interactive step-by-step guide overlaid on the dashboard, including for each step: replaying the specific user interactions relevant to the step on the linked dashboard components; and displaying the explanatory title and short description as text overlays.

In some implementations, changing the communication intent at the tour level regenerates all steps, and changing the intent at the step level regenerates only the corresponding step

In some implementations, the method further includes automatically generating multiple data tours for the dashboard based on different communication intents, and providing an interface for a user to select and customize the generated data tours.

In some implementations, the method further includes receiving a selection of the communication intent, wherein the communication intent is selected from a group consisting of: data facts/insights comprising interesting data highlights, interaction guide comprising how to use/interact with the dashboard, and dashboard composition and semantics comprising how to read/interpret the dashboard.

In some implementations, the group further includes other type, which provides the ability to tell a different story than the data facts/insights, interaction guide, and dashboard composition and semantics, wherein the other type of communication intent requires additional instructions to be provided by an author.

In some implementations, the method further includes providing an option for authors to select or filter what actions are meant to be captured during the recording of user interactions.

In some implementations, the interface for editing the data tour includes options for: (i) editing global features including changing tour type, providing custom generation instructions, and editing tour title, (ii) editing step features, (iii) capturing or inserting new interactive steps, (iv) adding new non-interactive steps, and (v) deleting steps.

In some implementations, presenting the data tour includes providing replay options for playing (i) a whole tour, and (ii) an individual step.

In some implementations, the text overlays are positioned close to where the interaction took place for interactive steps and at the center of the dashboard for non-interactive steps.

In some implementations, the communication intent is interaction guide, and the method further includes: tailoring the recorded user interactions to demonstrate basic dashboard navigation and functionality, generating explanatory titles and descriptions that focus on how to use and interact with different dashboard components, including options in an editing interface to add additional explanations for specific dashboard interactions, and enhancing the interactive step-by-step guide with highlighted UI elements to guide users through various interaction points.

In some implementations, the communication intent is data facts/insights, the method further includes: tailoring the recorded user interactions to reveal key data insights or trends; generating explanatory titles and detailed descriptions that highlight interesting data points; including options in an editing interface to add statistical context or comparative data; and enhancing the interactive step-by-step guide with data visualizations that emphasize notable facts or insights.

In some implementations, the communication intent is dashboard composition and semantics, the method further includes: tailoring the recorded user interactions to showcase different parts of the dashboard and their meanings; generating clear, descriptive titles and explanations for each dashboard component; providing options in an editing interface to add detailed interpretations of charts, graphs, and other data representations; and providing overlays in the interactive step-by-step guide that explain how to read and interpret different elements of the dashboard.

In some implementations, the communication intent is other than interaction guide, data facts/insights, and dashboard composition and semantics, the method further includes: prompting to provide additional instructions for the desired narrative or explanation; tailoring the recorded user interactions based on the additional instructions; generating custom titles and descriptions that align with an intended story or explanation; providing options in an editing interface to refine the custom narrative and add contextual information; and enhancing the interactive step-by-step guide with features that support a unique storytelling approach.

In some implementations, the method further includes: providing an interface to switch between different communication intents; automatically adjusting the focus and content of the data tour based on the selected communication intent; and providing intent-specific editing options and enhancements for each type of communication intent.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

1. A computer-implemented method for creating and presenting interactive data tours for dashboards, the method comprising:
receiving a communication intent for a data tour of a dashboard;
recording user interactions with components of the dashboard;
generating a sequence of steps for the data tour based on the recorded user interactions, wherein each step is linked to one or more dashboard components;
generating, using a Large Language Model (LLM), an explanatory title and a short description based on the linked dashboard components and the communication intent, for each step in the sequence of steps;
presenting an interface for editing the data tour;
receiving edits to the data tour through the presented interface;
storing the edited data tour; and
in response to a request to play the data tour, presenting the edited data tour as an interactive step-by-step guide overlaid on the dashboard, including for each step:
replaying specific user interactions relevant to the step on the linked dashboard components; and
displaying the explanatory title and short description as text overlays.

2. The method of claim 1, wherein the interface enables editing of the explanatory title and short description for each step.

3. The method of claim 1, wherein the interface enables regeneration of content for individual steps according to at least selection of a content type from predefined options.

4. (canceled)

5. The method of claim 1, wherein the interface enables addition, removal, and reordering of steps in the sequence, including providing insertion points in the data tour.

6. The method of claim 1, wherein:
the interface enables refinement of the communication intent at an entire data tour level or at individual step levels
changing the communication intent at the tour level regenerates all steps; and
changing the communication intent at the step level regenerates only the corresponding step.

7. (canceled)

8. The method of claim 1, wherein recording user interactions comprises capturing at least one of: mouse clicks, keyboard inputs, scroll events, and changes to dashboard settings or filters.

9. The method of claim 1, wherein generating the sequence of steps comprises:
analyzing the recorded user interactions to identify distinct actions or sets of actions; and
creating a step for each distinct action or set of actions,
wherein actions that derive from the same interaction event are grouped within the same step.

10. (canceled)

11. The method of claim 1, wherein generating the explanatory title and short description using the LLM comprises:
providing the LLM with context about the dashboard, the linked components, the recorded user interactions, and the communication intent; and
receiving generated text from the LLM based on the provided context.

12. The method of claim 1, further comprising:
automatically generating multiple data tours for the dashboard based on different communication intents; and
providing an interface for a user to select and customize the generated data tours.

13. The method of claim 1, further comprising:
receiving a selection of the communication intent, wherein the communication intent is selected from a group consisting of:
data facts/insights comprising interesting data highlights;
interaction guide comprising how to use/interact with the dashboard;
dashboard composition and semantics comprising how to read/interpret the dashboard; and
other type of communication intent comprising a capability to tell a different story than the data facts/insights, interaction guide, and dashboard composition and semantics, wherein the other type of communication intent requires additional instructions to be provided by a user.

14. (canceled)

15. The method of claim 1, further comprising providing an option for authors to select or filter what actions are meant to be captured during the recording of user interactions.

16. The method of claim 1, wherein the interface for editing the data tour includes options for: (i) editing global features including changing tour type, providing custom generation instructions, and editing tour title, (ii) editing step features, (iii) capturing or inserting new interactive steps, (iv) adding new non-interactive steps, and (v) deleting steps.

17. (canceled)

18. The method of claim 1, wherein the text overlays are positioned close to where the interaction took place for interactive steps and at the center of the dashboard for non-interactive steps.

19. The method of claim 1, wherein the communication intent is interaction guide, the method further comprising:
tailoring the recorded user interactions to demonstrate basic dashboard navigation and functionality;
generating explanatory titles and descriptions that focus on how to use and interact with different dashboard components;
including options in an editing interface to add additional explanations for specific dashboard interactions; and
enhancing the interactive step-by-step guide with highlighted UI elements to guide users through various interaction points.

20. The method of claim 1, wherein the communication intent is data facts/insights, the method further comprising:
tailoring the recorded user interactions to reveal key data insights or trends;
generating explanatory titles and detailed descriptions that highlight interesting data points;
including options in an editing interface to add statistical context or comparative data; and
enhancing the interactive step-by-step guide with data visualizations that emphasize notable facts or insights.

21. The method of claim 1, wherein the communication intent is dashboard composition and semantics, the method further comprising:
tailoring the recorded user interactions to showcase different parts of the dashboard and their meanings;
generating clear, descriptive titles and explanations for each dashboard component;
providing options in an editing interface to add detailed interpretations of charts, graphs, and other data representations; and
providing overlays in the interactive step-by-step guide that explain how to read and interpret different elements of the dashboard.

22. The method of claim 1, wherein the communication intent is other than interaction guide, data facts/insights, and dashboard composition and semantics, the method further comprising:
prompting to provide additional instructions for a desired narrative or explanation;
tailoring the recorded user interactions based on the additional instructions;
generating custom titles and descriptions that align with an intended story or explanation;
providing options in an editing interface to refine a custom narrative and add contextual information; and
enhancing the interactive step-by-step guide with features that support a unique storytelling approach.

23. The method of claim 1, further comprising:
providing an interface to switch between different communication intents;
automatically adjusting a focus and content of the data tour based on a selected communication intent; and
providing intent-specific editing options and enhancements for each type of communication intent.

24. A computer system for creating and presenting interactive data tours for dashboards, comprising:
one or more processors; and
memory;
wherein the memory stores one or more programs configured for execution by the one or more processors, and the one or more programs comprising instructions for:
receiving a communication intent for a data tour of a dashboard;
recording user interactions with components of the dashboard;
generating a sequence of steps for the data tour based on the recorded user interactions, wherein each step is linked to one or more dashboard components;
generating, using a Large Language Model (LLM), an explanatory title and a short description based on the linked dashboard components and the communication intent, for each step in the sequence of steps;
presenting an interface for editing the data tour;
receiving edits to the data tour through the presented interface;
storing the edited data tour; and
in response to a request to play the data tour, presenting the edited data tour as an interactive step-by-step guide overlaid on the dashboard, including for each step:
replaying specific user interactions relevant to the step on the linked dashboard components; and
displaying the explanatory title and short description as text overlays.

25. A non-transitory computer readable storage medium storing one or more programs configured for execution by a computer system having a display, one or more processors, and memory, the one or more programs comprising instructions for:
receiving a communication intent for a data tour of a dashboard;
recording user interactions with components of the dashboard;
generating a sequence of steps for the data tour based on the recorded user interactions, wherein each step is linked to one or more dashboard components;
generating, using a Large Language Model (LLM), an explanatory title and a short description based on the linked dashboard components and the communication intent, for each step in the sequence of steps;
presenting an interface for editing the data tour;
receiving edits to the data tour through the presented interface;
storing the edited data tour; and
in response to a request to play the data tour, presenting the edited data tour as an interactive step-by-step guide overlaid on the dashboard, including for each step:
replaying specific user interactions relevant to the step on the linked dashboard components; and
displaying the explanatory title and short description as text overlays.
